(19) United States
(12) Patent Application Publication
(10) Pub. No.: US 2025/0294507 A1
(43) Pub. Date: Sep. 18, 2025

(54) METHODS, APPARATUS, AND SYSTEM FOR LOW-POWER-MODE USER EQUIPMENT POSITIONING

(71) Applicant: Huawei Technologies Co., Ltd., Shenzhen (CN)

(72) Inventors: Ahmed Wagdy Abdelwahab Shaban, Kanata (CA); Shahram Shahsavari, Ottawa (CA); Alireza Bayesteh, Brossard (CA)

(21) Appl. No.: 19/216,111

(22) Filed: May 22, 2025

Related U.S. Application Data
(63) Continuation of application No. PCT/CN2022/133734, filed on Nov. 23, 2022.

(51) Int. Cl. H04W 64/00; H04B 7/06

(52) U.S. Cl. CPC H04W 64/00; H04B 7/0617

(57) ABSTRACT

Aspects of the present application are related to configuring a target user equipment to alter, with minimal or no baseband processing, an incoming positioning signal, in a manner that takes into consideration various power or energy modes (e.g., regular power, low power, extremely low power) for the target user equipment. Through appropriate configuration of the positioning signal, the parameters reported, by anchor nodes, to a position-obtaining node may be shown to allow the position-obtaining node to obtain a position for the target user equipment, even though the target user equipment is in one of a plurality of low power modes.

### CROSS-REFERENCE TO RELATED APPLICATION

This application is a continuation of International Application No. PCT/CN2022/133734, filed on Nov. 23, 2022, the disclosure of which is hereby incorporated by reference in its entirety.

### TECHNICAL FIELD

The present disclosure relates, generally, to user equipment positioning and, in particular embodiments, to positioning for user equipment in a low-power-mode.

### BACKGROUND

The recent history of wireless communication systems has shown improvements in energy efficiency. Accordingly, it is anticipated that designs for future wireless communication systems will aim to enhance overall energy efficiency of terminals and infrastructure, while fulfilling stringent constraints of connectivity. The design of such future wireless communication systems may include energy-aware solutions and may introduce new operation modes, such as several degrees of low-power operation modes.

### SUMMARY

Aspects of the present application are related to configuring a target user equipment (UE) to alter, with minimal or no baseband processing, an incoming positioning signal, in a manner that takes into consideration various power/energy modes (regular power, low power, extremely low power) for the target UE. Notably, various power/energy modes are expected to be dominant in future wireless communication systems. By configuring a target UE before entry into one of a plurality of low power modes, aspects of the present application benefit from being operational in the context of target UE that is not in a connected state. Through appropriate configuration of the positioning signal, the parameters reported, by anchor nodes, to a position-obtaining node may be shown to allow the position-obtaining node to obtain a position for the target UE, even though the target UE is in one of a plurality of low power modes. Notably, the position-obtaining node may be implemented as a location management function (LMF) or a sensing management function (SMF).

Conventional positioning procedures may be shown to require baseband signal processing. Baseband signal processing may be shown to involve use of power-hungry devices, such as analog-to-digital converters. This use of power-hungry devices may be shown to increase the energy required for collecting and processing measurements at devices configured to carry out or assist with the conventional positioning procedures. Moreover, the conventional positioning procedures may be shown to use computationally intensive operations at these devices.

The conventional positioning procedures may be shown to utilize a small number of anchor nodes with fixed locations for providing positioning reference signals (PRS). This conventional approach may be shown to lead to a relatively large average distance between anchor nodes and target user UEs. Such relatively large average distances may be shown to lead directly to relatively large required average power of the PRS to be received at target UEs. The use of multiple devices may be shown to directly increase the average energy and power required for the conventional positioning procedures.

The conventional positioning procedures may also be shown to use a relatively high level of synchronization between all terminals (anchor nodes and/or target UE) to achieve an acceptable positioning accuracy. The relatively high level of synchronization may be shown to introduce overhead and latency to the conventional positioning procedures. Overhead and latency may be shown to implicitly increase overall energy consumption used for obtaining accurate position information.

The conventional positioning procedures are known to have a disadvantage of having been developed for obtaining a position for target UE when the target UE is in a connected state, with regular energy consumption and regular power transmission.

By configuring a target UE before entry into one of a plurality of low power modes, aspects of the present application allow for obtaining a position for a target UE that is not in a connected state. By configuring a target UE to alter, with minimal or no baseband processing, an incoming positioning signal, aspects of the present application allow for obtaining a position for the target UE when the target UE is in one of a plurality of power/energy modes.

According to an aspect of the present disclosure, there is provided a method of obtaining a position of a target UE. The method includes transmitting, to the target UE before the target UE enters into a low power mode, configuration information for a first positioning signal. The method optionally includes transmitting, to a network node, an indication that the network node has been assigned as an anchor node for the target UE. The method further includes transmitting, to the network anchor node, the first positioning signal configuration information. The method further includes receiving, from the network anchor node, an indication of a plurality of parameters, the plurality of parameters obtained by the network anchor node from a second positioning signal received, at the network anchor node, from the target UE. The second positioning signal is based on the first positioning signal. The method further includes obtaining position information for the target UE from the plurality of parameters.

According to an aspect of the present disclosure, there is provided a method of facilitating obtaining a position of a target UE. The method may optionally include initially receiving, at a network node, an indication that the network node has been assigned as an anchor node for the target UE. The method includes receiving, at the network anchor node, configuration information. The method further includes receiving, at the network anchor node, a second positioning signal, wherein the second positioning signal corresponds to a first positioning signal as altered by the target UE, wherein the first positioning signal has been defined in the configuration information. The method further includes obtaining, at the network anchor node, a plurality of parameters from the second positioning signal. The method further includes transmitting, from the network anchor node to a position-obtaining node, indications of the plurality of parameters.

According to an aspect of the present disclosure, there is provided a method of facilitating obtaining a position of a target UE. The method includes receiving, at the target UE, configuration information for a positioning signal, receiving, at the target UE, a first positioning signal according to the configuration information, altering, at the target UE, the first positioning signal to generate a second positioning signal and transmitting, at the target UE, the second positioning signal.

According to further aspects of the present disclosure, there are provided an apparatus, a processor of said apparatus, and a computer program product for execution by said apparatus, where the apparatus performs any of the above methods.

According to another aspect of the present disclosure, there is provided a system comprising a first network node for obtaining a position of a target user equipment, and a second network node in communication with the first network node. The first network node is configured to transmit configuration information for a first positioning signal, and receive a plurality of parameters obtained from a second positioning signal based on the first positioning signal, in order to obtain position information for the target UE from the plurality of parameters. The second network node is configured to receive the second positioning signal from the target UE, and transmit to the first network node indications of the plurality of parameters obtained from the second positioning signal, where the second positioning signal corresponds to the first positioning signal as altered by the target UE.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmits receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates signals in a positioning procedure for a target UE in a context of a plurality of terminals, including the sensing management function of FIG. 5, a positioning signal transmitting/reception anchor (TX/RX-AN) node and a plurality of positioning signal reception (RX-AN) nodes, in accordance with aspects of the present application;

FIG. 7 illustrates example steps in a method of orchestrating, at the sensing management function of FIG. 5, a positioning procedure, in accordance with aspects of the present application;

FIG. 8 illustrates example steps in a method of carrying out a positioning procedure at the TX/RX-AN node of FIG. 6, in accordance with aspects of the present application;

FIG. 9 illustrates example steps in a method of carrying out a positioning procedure at the target UE of FIG. 6, in accordance with aspects of the present application;

FIG. 10 illustrates example steps in a method of carrying out a positioning procedure at one of the RX-AN nodes of FIG. 6, in accordance with aspects of the present application;

FIG. 11 illustrates that the target UE of FIG. 6 may include a matched filter, in accordance with aspects of the present application;

FIG. 12 illustrates transmission, by a TX-AN node, of a first positioning signal that is altered by a target UE to be a second positioning signal that is received by an RX-AN node, in accordance with aspects of the present application;

FIG. 13A illustrates transmission, by a TX-AN node, of a first positioning signal that is received by an RX-AN node, in accordance with aspects of the present application;

FIG. 13B illustrates transmission, by a TX-AN node, of a first positioning signal that is altered by a target UE to be a second positioning signal that is received by an RX-AN node, in accordance with aspects of the present application;

FIG. 13C illustrates an ellipse with one focal point at the location of the TX-AN node of FIG. 13A and another focal point at the location of the RX-AN node of FIG. 13A, in accordance with aspects of the present application;

FIG. 14 illustrates a first matched filter that may be used by the RX-AN node of FIG. 13A and a second matched filter that may be used by the RX-AN node of FIG. 13A, in accordance with aspects of the present application;

FIG. 15A illustrates transmission, by a TX-AN node, of a first positioning signal that is altered by a target UE to be a second positioning signal that is received by each of a pair of RX-AN nodes, in accordance with aspects of the present application;

FIG. 15B illustrates a hyperbola with one focal point at the location of each of the pair of RX-AN nodes of FIG. 15A, in accordance with aspects of the present application;

FIG. 16 illustrates transmission, by a TX-AN node, of a first positioning signal that is altered by a target UE to be a second positioning signal that is received by an RX-AN node, in accordance with aspects of the present application;

FIG. 17 illustrates a grid of resources defined by frequency slots and time slots, thereby allowing the sensing management function of FIG. 5 to assign a resource to the sensing of a target UE in a particular low power mode among a plurality of low power modes, in accordance with aspects of the present application;

FIG. 18 illustrates a strategy for enhancing distinguishability of received chirp-based positioning signals through the configuring of the transmission of the chirp-based positioning signals to occur using distinct chirp rates, in accordance with aspects of the present application;

FIG. 19 illustrates a grid of resources defined by frequency slots and time slots, wherein a given time/frequency resource may have chirp-based positioning signals defined to use a single chirp rate or a plurality of chirp rates, in accordance with aspects of the present application; and

FIG. 20 illustrates, in a signal flow diagram, communication between the sensing management function of FIG. 5, a TX-AN node, an RX-AN node and a UE, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

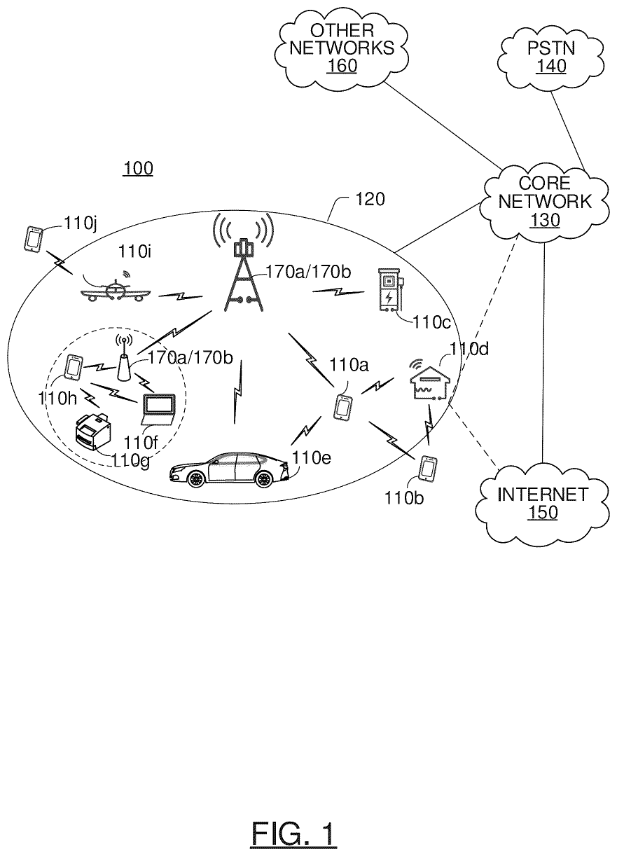

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

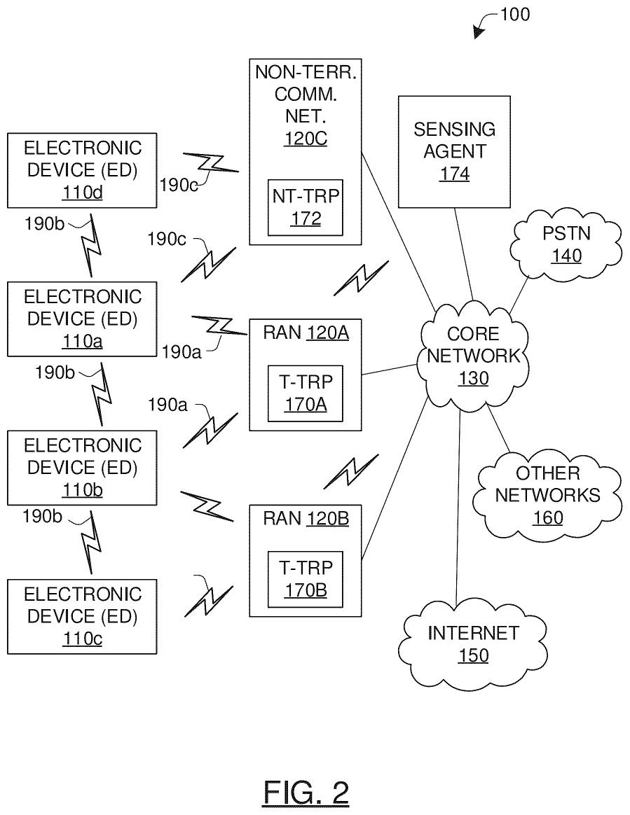

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

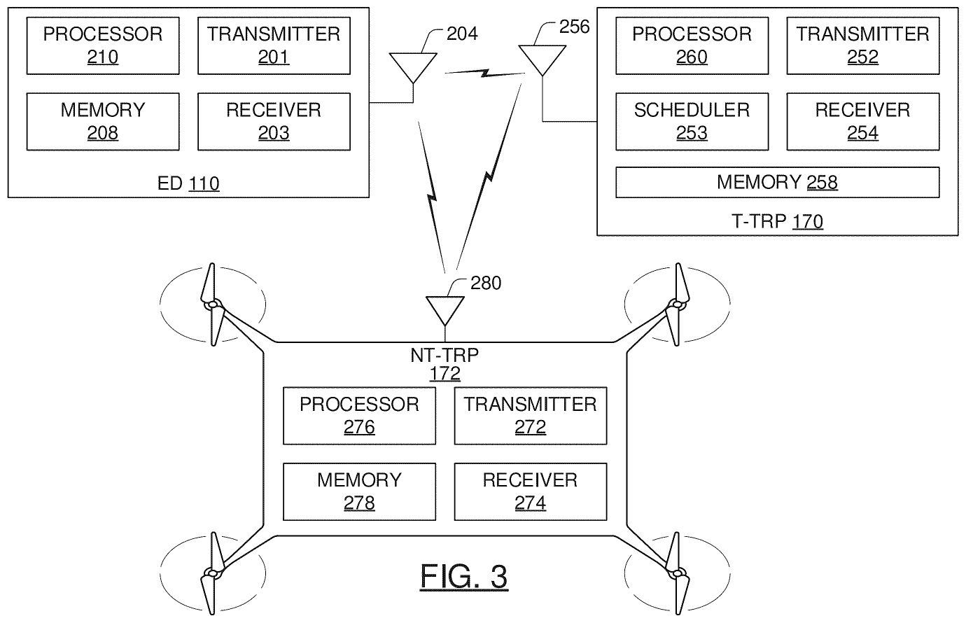

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

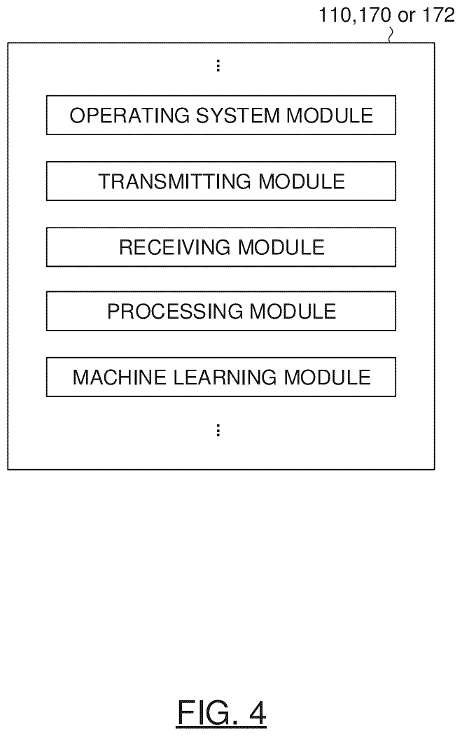

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents 174 may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

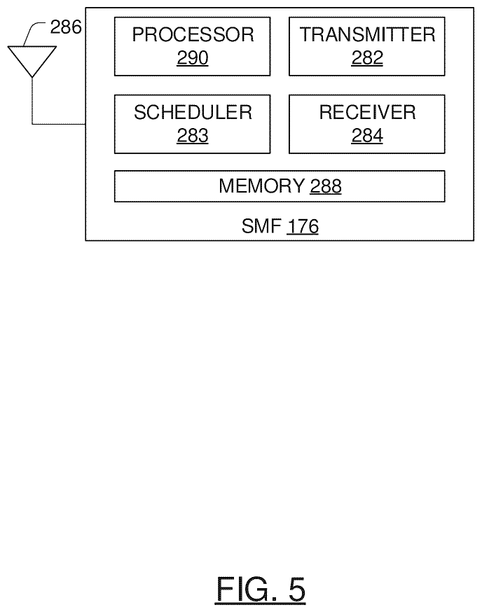

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from a starting frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp rate. The bandwidth of the linear chirp signal may be defined as B=f_{chirp1}−f_{chirp0} and the time duration (the period) of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

For a future wireless communication system, wherein new operation modes, such as low-power operation modes, have been introduced, it follows that various functions may be adapted for use in the new operation modes. For example, sensing methods may be adapted for a low-power mode. Similarly, communication methods may be adapted for a low-power mode.

While high-accuracy positioning is ordinarily considered to be a goal in conflict with energy efficiency, this may not be strictly true. Indeed, accurate positioning may lead to lower overall power consumption. Position information is expected to be a service provided to users of a network. As well, position information may be used in facilitating other services and functionalities provided by the network in position-aware communications. For instance, position information may be leveraged to facilitate initial access, beam training and synchronization, thereby enhancing network resource management. Clearly, the availability of position information at network nodes may be shown to be beneficial in reducing system design complexity, reducing signaling overhead and reducing latency of many communication and sensing procedures, thereby reducing overall power consumption.

Current positioning techniques, such as downlink Time Difference of Arrival (DL-TDoA), downlink Angle of Departure (DL-AoD), Multi-cell round trip time (Multi-RTT), and their uplink variants, are designed without taking energy consumption into consideration. A low power positioning method may be discussed from two different perspectives, namely, a network perspective and a UE perspective.

From the UE perspective, current positioning procedures require the UE to be in a connected state to: receive and process synchronization signal blocks (SSB); and to receive, decode and process positioning reference signals (PRS). These current positioning procedures necessitate frequently “waking up” UEs, i.e., transitioning the UEs from an RRC_IDLE state to an RRC_CONNECTED state. These current positioning procedures may be shown to directly increase energy consumption at the UE, where the transition from the RRC_IDLE state to the RRC_CONNECTED state requires a relatively large amount of signaling between the UE and networks nodes. Furthermore, these current positioning procedures may be shown to decrease a duration that the UE may be expected to spend in an energy-saving mode, such as the RRC_IDLE state. Additionally, decoding and processing SSB and PRS at the UE is known to involve computationally intensive digital processing that involves turning on power-hungry hardware, such as analog-to-digital converters (ADCs). It should be understood that, while aspects of the present application are discussed in the context of RRC operational states, there might be other new states corresponding to a wider variety of operational states and different power modes, to be introduced in the future.

From the network perspective, it may be considered that current positioning methods have two main issues related to increasing power consumption. A first issue is related to the large transmit power of PRS (in the downlink direction) or SRS (in the uplink direction) required to guarantee coverage and reliable reception, either at other network nodes or at UEs. Particularly, current positioning procedures are known to depend upon using a small number of fixed-position network nodes as anchor nodes that transmit positioning reference signals for locating UEs. Consequently, most of the fixed-position anchors have higher chances of being far from the target UE (the UE that is being localized/positioned), thereby increasing the power and energy required for transmitting PRS. This first issue is similarly present in current positioning procedures in the uplink direction. A second issue is related to high signaling and feedback overheads required to achieve the high synchronization level required either between UEs and network nodes or among the anchors themselves. For instance, in a multi-cell RTT positioning procedure, each anchor may transmit a dedicated PRS and received a dedicated SRS. This indirectly increases the overall energy consumption of the positioning procedures.

The 3rd Generation Partnership Project (3GPP) is known to produce a global standard for fifth generation (5G) mobile wireless communication networks. In Release 17 of the global standard (available at www.3gpp.org), there are some work items on RRC_INACTIVE state positioning. These work items allow for performing positioning procedures during RRC_INACTIVE state. However, the work items have no focus on low-power consumption. Instead, the work items appear to have been introduced to reduce the latency in transitioning from the RRC_IDLE state to the RRC_CONNECTED state. Lower power consumption may be seen as a by-product of carrying out these work items, due to a reduction of the processes (receiving signaling, sensing and collecting measurements) performed by a UE in the RRC_INACTIVE state compared to the processes performed by a UE in the RRC_CONNECTED state. It may be considered that the positioning procedures in these work items have the same work-flow of current positioning procedures, in that the positioning procedures still use relatively high-energy-consumption digital baseband processing procedures and still depend on a small number of fixed anchors in positioning.

The digital baseband processing procedures, performed at a UE in relation to downlink positioning, include: estimating downlink reference signal time difference (DL RSTD); estimating downlink position reference signal reference signal received power (DL PRS-RSRP); estimating downlink position reference signal reference signal received path power (DL PRS-RSRPP); and estimating UE Rx-Tx time difference.

In U.S. Pat. No. 11,290,960, it was proposed to use passive components in devices (like UEs) in the RF circuitry (see FIG. 2 of U.S. Pat. No. 11,290,960). It is proposed to equip the devices with some passive components and circuitry. The passive components and circuitry may be used when the device is in an RRC_IDLE state or in an RRC_INACTIVE state or, more generally, in a low power mode. The passive components and circuitry may be used to forward/reflect incoming signals from a first terminal such that the forwarded/reflected signals are received at a second terminal. The device may switch between an active mode and a passive mode, where each mode functions in a different device state. The device may switch into the active mode responsive to switching into an RRC_CONNECTED state. The device may switch into the passive mode responsive to switching into an RRC_IDLE state or an RRC_INACTIVE state or, more generally, into a low power mode. The switching may be seen to allow the device to save power. Conveniently, when the device is in the RRC_IDLE state or the RRC_INACTIVE state, the device may perform extended functions not typically available in those states, without requiring the device to wake up.

In PCT/CN2021/075136, it is proposed that a network entity may be configured to detect UEs even when the UEs are in the idle/sleep state. In this method, the network entity sends a common sensing signal with a center frequency, f₀. Each distinct UE is configured to passively reflect the common sensing signal at a distinct frequency, fₖ. A super-UE or relay assists the TRP in receiving the reflections of the common sensing signal. In this way, the TRP can detect a presence of each UE and an approximate position of each UE.

Aspects of the present application relate to positioning methods that are tailored to UEs in low-power modes and extremely low-power modes. The positioning methods may be shown to address disadvantages of conventional positioning methods and in that the positioning methods allow for accommodation of different aspects of various states/modes of UEs.

Conveniently, positioning methods representative of aspects of the present application may be shown to feature relatively low power consumption, feature a relatively low computational complexity burden and feature a relatively high accuracy, while relaxing synchronization-level between terminals. Indeed, positioning methods representative of aspects of the present application may be shown to consume relatively lower power when compared to current positioning methods. This relatively lower power consumption may be shown to be achieved based on use of chirp-based reference signals that may be processed, at the UE, using either so-called RF-dominant processing or RF-only and passive processing. This relatively lower power consumption may also be shown to be achieved based on utilizing connected UEs (capable UEs that are willing to cooperate) proximate to the UE for which a position is to be determined. The connected UEs may be shown to work as anchor nodes capable of transmitting positioning reference signals. The use of proximate connected UEs may be shown to allow for short-range communications. In the future, UEs that are called “connected UEs” herein need not necessarily be in the known RRC_CONNECTED state (based on the NR definition) to perform sensing tasks representative of aspects of the present application. Accordingly, it should be understood that the generic term “network node” for an RX-AN may refer to a UE in a connected state or not in a connected state.

It is known that a link-budget for reliable reception of transmitted reference signals diminishes with range. Positioning methods representative of aspects of the present application may be shown to simplify processing and detection operations at the anchor nodes. This simplification may be shown to reduce power consumption at anchor nodes. It may be shown that a by-product of positioning methods representative of aspects of the present application is an alleviation of synchronization error.

Aspects of the present application relate to tailoring positioning methods to accommodate capabilities associated with UEs in different power modes. It may be safely assumed that a UE's power or energy status or mode may be one of three modes: a regular power mode; a low power mode; and an extremely low-power mode.

In the regular power mode, the UE has moderate to high energy. Accordingly, the UE can afford turning on both RF analog circuitry and baseband digital circuitry. Furthermore, the UE can afford to handle computationally intensive operations. In addition, the regular power mode is expected to allow the UE to process and transmit RF signals with relatively high power, such that the RF signals may be reliably received at network nodes, which are, typically, located relatively far from the UE.

In the low power mode, the UE has low energy. Accordingly, the UE cannot afford to turn on both RF analog circuitry and full baseband digital circuitry. Furthermore, the UE cannot afford to handle computationally intensive operations. Instead, the UE can afford turning on only RF analog circuitry. Furthermore, the UE may afford to carry out limited digital processing using, for example, low-rate ADCs. In addition, the low power mode is expected to allow the UE to process and transmit RF signals with sufficient power to be reliably received at network nodes, which are, typically, located relatively far from the UE.

In the extremely low power mode (either a class A or a class B, as defined herein), the UE has an extremely low energy level. Accordingly, the UE cannot afford to transmit RF signals with sufficient power to be reliably received at network nodes. Moreover, depending on the energy that the UE has, the UE may decide to turn off digital baseband circuitry and allow analog RF-only or passive RF processing (this is referenced, herein, as extremely low power mode class B) or to allow analog RF processing with limited digital processing (this is referenced, herein, as extremely low power mode class A).

It is known that UEs in different low power modes are susceptible to loss of tight synchronization with network nodes over time. This loss of tight synchronization may be blamed on not sending or receiving synchronization signals. The decision to not send or receive synchronization signals may be implemented for the sake of conserving power. The loss of tight synchronization may be blamed on an internal drift of internal UE clocks that are known to benefit from continuous maintenance. The loss of tight synchronization may be shown to directly increase a difficulty of carrying out a positioning process and may be shown to dramatically reduce accuracy of any positioning procedure that is carried out. For example, it may be shown that a 10-nanosecond synchronization error induces a 3-meter positioning error. For that reason, aspects of the present application may be understood to take relaxed synchronization constraints into consideration. That is, aspects of the present application may be understood to incorporate countermeasures to diminish losses of tight synchronization.

Some aspects of the present application relate to positioning procedures specific to UEs in low power mode. Further aspects of the present application relate to positioning procedures specific to UEs in extremely low power modes. Aspects of the present application relate to utilizing analog RF-dominant processing to transmit and receive especially designed chirp-based positioning signals at all terminals, including anchor nodes, connected UEs, and UEs in low-power modes. Aspects of the present application may be realized using a “ping-pong” (transmit-process-retransmit/backscatter) chirp-based positioning technique. In aspects of the present application, a certain anchor node transmits (first leg) a chirp-based positioning signal. Upon receipt of an incoming chirp-based positioning signal, a target UE backscatters or broadcasts (second leg) the received chirp-based positioning signal or a time-shifted version of the received chirp-based positioning signal. Upon receipt, at an anchor node, of a chirp-based positioning signal from the target UE, the anchor node may process the chirp-based positioning signal. Aspects of the present application may be shown to naturally diminish synchronization error between the target UE and the anchor node. Aspects of the present application may be shown to, in the second leg, allow for a chirp-based positioning signal from the target UE to be received at a plurality of anchor nodes. The plurality of anchor nodes may be efficiently utilized to diminish synchronization error between anchors nodes. Accordingly, positioning procedure reliability may be improved and the accuracy of the positioning procedure may be increased.

Aspects of the present application may be shown to apply to scenarios wherein a UE in a low power mode is to be positioned or localized with relatively high accuracy. The UE may be loosely synchronized with one or more network nodes due to having been in the low power mode for a relatively long time. There are four main nodes/terminals involved in the presented aspects of the present application: the SMF 176; a transmitting anchor (TX-AN); a receiving anchor (RX-AN); and a target UE.

As discussed hereinbefore, the SMF 176 is a physical or a logical network entity that may be tasked with orchestrating positioning procedures representative of aspects of the present application. The SMF 176 may be co-located at a network node with other network functions or entities; therefore, the SMF 176 may also be a same network node as a TX-AN or RX-AN, in the case where the TX-AN or RX-AN is a network node. Primary duties of the SMF 176 include: managing time and frequency resources; managing positioning signal configurations; monitoring status of UEs in a given area; sending positioning signal configurations to TX-ANs, RX-ANs and target UEs; receiving measurement information from RX-ANs; and processing the measurement information to determine respective positions of target UEs.

The TX-AN is a node, either a network node or a UE in an RRC_CONNECTED state, that is configured to transmit positioning reference signals according a configuration provided by the SMF 176. The position of the TX-AN node is known at the SMF 176. The main duties of the TX-AN include: receiving, from the SMF 176, a positioning signal configuration; and transmitting a positioning reference signal based on the positioning signal configuration.

The RX-AN is a node, either a network node or a UE in an RRC-CONNECTED state, that is configured to reliably receive sensing reference signals and to process the sensing reference signals to collect some measurements according to a configuration provided by the SMF 176. The position of the RX-AN node is known at the SMF 176. The main duties of the RX-AN include: receiving, from the SMF 176, a positioning signal configuration; receiving backscattered or time-shifted positioning reference signals; collecting measurements on the received signals; performing parameter estimation, based on the positioning signal configuration defined by the SMF 176, to obtain estimated parameters; and feeding back the estimated parameters and collected measurements to the SMF 176. Notably, in some positioning procedures, there are some nodes that work as an RX-AN node and as an TX-AN node.

The target UE is a UE in one of the low power modes. Aspects of the present application relate to an objective to localize or position the target UE. The target UE is configured to interact minimally with the positioning reference signals. The main duties of the target UE include: indicating, to the SMF 176, a selected low power mode, among a plurality of different low power modes, into which the target UE is going to enter; receiving, from the SMF 176 before entering into the selected low power mode, a positioning signal configuration; receiving a positioning signal; applying a signature to the positioning signal to obtain a signed positioning signal; and time-shifting and retransmitting or backscattering the signed positioning signal.

Aspects of the present application relate to a positioning procedure for target UEs in a low power mode. This positioning procedure has a large coverage area and makes use anchor nodes and target UEs transmitting signals with a regular power configuration.

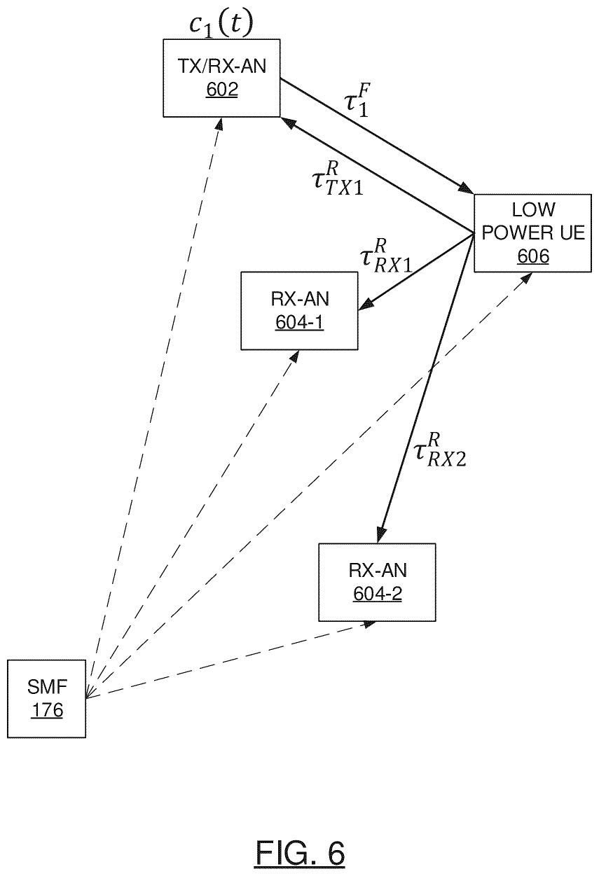

Signals in a positioning procedure for a target UE 606 are illustrated in FIG. 6 in context of a plurality of terminals. The terminals include a node 602 that is a combination of a TX-AN node and an RX-AN node, a first RX-AN node 604-1 and a second RX-AN node 604-2. A further network entity, e.g., the SMF 176, may be configured to orchestrate the positioning procedure, collect data measured at different terminals and determine the position of the target UE 606. As discussed hereinbefore, the SMF 176 may be a network entity unto itself or a logical function implemented by a TRP 170 or any network node.

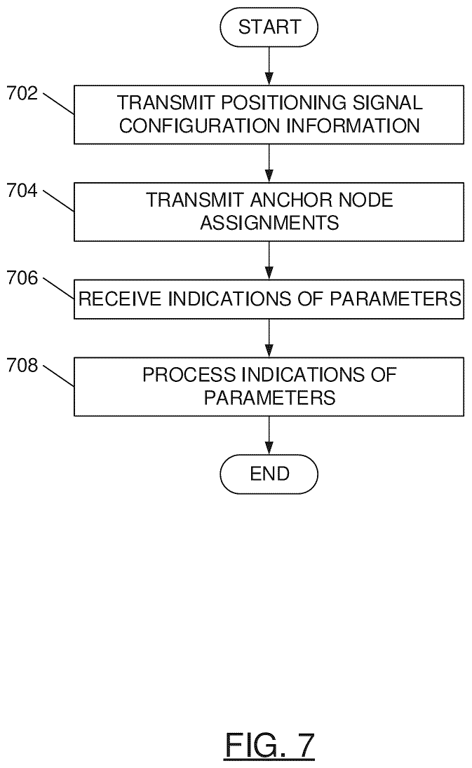

FIG. 7 illustrates example steps in a method of orchestrating, at the SMF 176, a positioning procedure. Before the target UE 606 enters into a low power mode, the SMF 176 provides (step 702) all the terminals involved in the positioning process with positioning signal configurations. The positioning signal configurations may include chirp-based positioning signal parameters, such as a chirp rate, a, a duration, T, and a starting frequency, fᵢ. The positioning signal configurations may further include time and frequency resources, transmit power and periodicity for the chirp-based positioning signals. The SMF 176 then transmits (step 704) assignments of anchor nodes (the TX/RX-AN node 602, the first RX-AN node 604-1, the second RX-AN node 604-2) for the target UE 606. In general, the SMF 176 may assign (step 704), as anchor nodes, positioning TRPs 170 (network nodes—not shown in FIG. 6) or other connected UEs. The SMF 176 may assign (step 704) a single TX-AN node and associate the single TX-AN node with a plurality of RX-AN nodes. It is expected that the SMF 176 will assign (step 704) the role of TX-AN node to a node that has a capability to receive chirp-based positioning signals in addition to having a capability to transmit chirp-based positioning signals. It follows that TX-AN nodes may be, more accurately, called TX/RX-AN nodes (as illustrated in FIG. 6). In some cases, for the sake of reliability of the positioning process, the SMF 176 may assign (step 704) more than one TX-AN node. In situations wherein more than one TX-AN node is assigned, each TX-AN node may be provided (step 702) with different positioning signal configurations (e.g., different starting frequency, fᵢ).

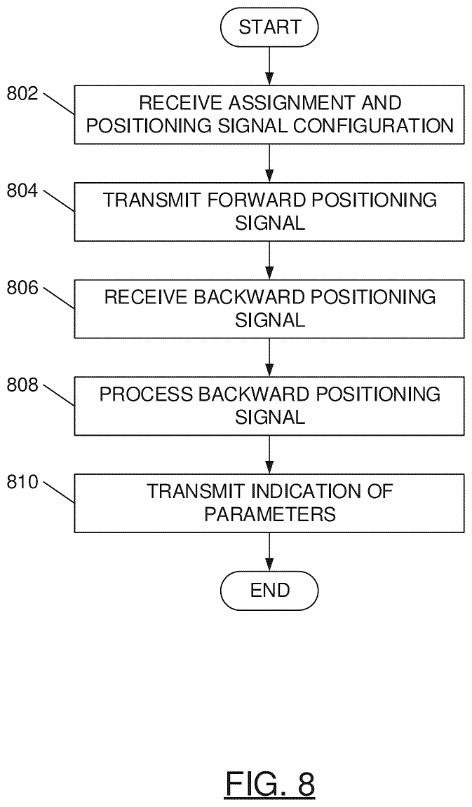

FIG. 8 illustrates example steps in a method of carrying out a positioning procedure at the TX/RX-AN node 602. The assigned TX/RX-AN node 602 initially receives (step 802), from the SMF 176, an assignment along with positioning signal configuration information. The TX/RX-AN 602 node then transmits (step 804) a first, or so-called “forward,” chirp-based positioning signal in accordance with the positioning signal configuration information. In those situations, wherein the SMF 176 assigns multiple TX/RX-AN nodes, the SMF 176 may provide, to an i^{th} TX/RX-AN node, positioning signal configuration information that includes a common chirp rate, α, and a starting frequency, fᵢ, that is specific to the i^{th} TX/RX-AN node. The selection of each starting frequency, fᵢ, for all i∈{1, . . . , N}, may be made in a manner that maintains orthogonality between the chirp-based positioning signals transmitted by anchor nodes that are serving a given target UE in a given frequency domain.

In those situations, wherein the SMF 176 assigns N TX/RX-AN nodes, the chirp-based positioning signal transmitted by an i^{th} TX/RX-AN node, where i=1, . . . , N, may be referenced as cᵢ(t). In these situations, the target UE 606 is expected to receive N chirp-based positioning signals, with each chirp-based positioning signal received with a different delay, i.e., cᵢ(t−Σᵢ^{F}), where τᵢ^{F} is a delay term that is representative of a time of flight/propagation delay associated with a forward (F) path to the target UE 606 from the i^{th} TX/RX-AN node. The N received chirp-based positioning signals may be referenced a “forward/first hop” chirp-based positioning signals. These chirp-based positioning signals may be expressed, mathematically, as cᵢ(t)=e^{j(2πf}^{ᵢ}^{t+παt}^{²}⁾.

In normal channel conditions, the SMF 176 may be expected to assign (step 704) only a single TX/RX-AN node, i.e., N=1, as illustrated in FIG. 6. Additionally, the single TX/RX-AN node 602 is expected to be, roughly, the nearest anchor node to the target UE 606. Such proximity may be shown to provide favorable conditions for reliable reception, at the target UE 606, of forward chirp-based positioning signals. Such proximity may be shown to provide favorable conditions for reliable reception, at the TX/RX-AN node 602, of second, or so-called “reverse,” chirp-based positioning signals.

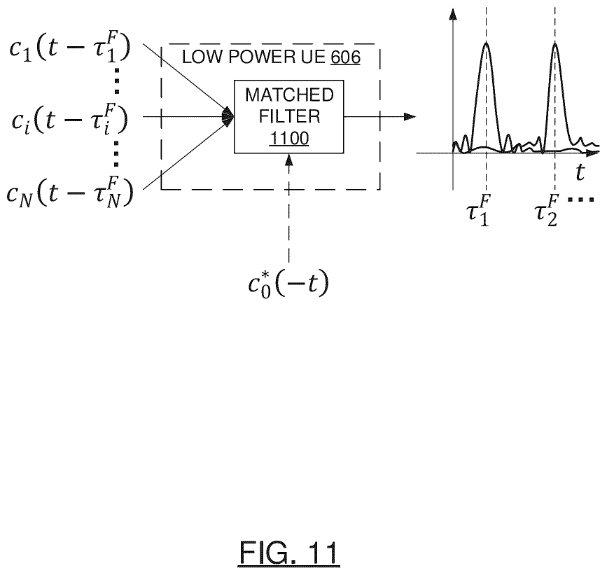

In case wherein there are more than one TX/RX-AN nodes, the chirp rates of the chirp signals may be expected to have the same, common chirp rate, α, and the quantity, N, of chirp-based positioning signals being transmitted need not be known at the target UE 606. The target UE 606 may activate a matched filter 1100 (see FIG. 11) that is configured with the common chirp rate, α. It follows that the target UE 606 may process received chirp-based positioning signals to obtain a plurality of peaks (τ₁^{F}, τ₂^{F}, . . . , τ_{N}^{F}). The plurality of peaks may be interpreted, at the target UE 606, as a plurality of detected delay values. Notably, the target UE 606 may detect these peaks, τᵢ^{F}, according to a clock that is local to the target UE 606. It should be well understood, then, that the detected delay values are biased by a TX-to-UE (“TX-UE”) synchronization error between a network clock and the clock that is local to the target UE 606. The delays may be expressed as

$${τ}_{i}^{F} = Δ {t}_{i} + \frac{{d}_{i}}{c} ,$$

where Δtᵢ=tᵢ−t₀ is representative of the TX-UE synchronization error, tᵢ is the time at the i^{th} TX/RX-AN node and t₀ is the time at the clock that is local to the target UE 606. Notably, values for the starting frequencies, fᵢ, may be uniquely mapped to individual ones of the plurality of TX/RX-AN nodes and the target UE 606. In other words, for the case of multiple TX/RX-AN nodes and, thereby, multiple starting frequencies, fᵢ, the starting frequencies, fᵢ, belong to a single target UE 606. Additionally, for positioning a single target UE 606, a common set of RX/AN nodes may be associated with multiple TX/RX-AN nodes or distinct sets of RX/AN nodes may be associated to corresponding TX/RX-AN nodes. A decision between these options may be made at the SMF 176 and may be based on achieving a certain accuracy and/or a certain reliability level for a given positioning procedure.

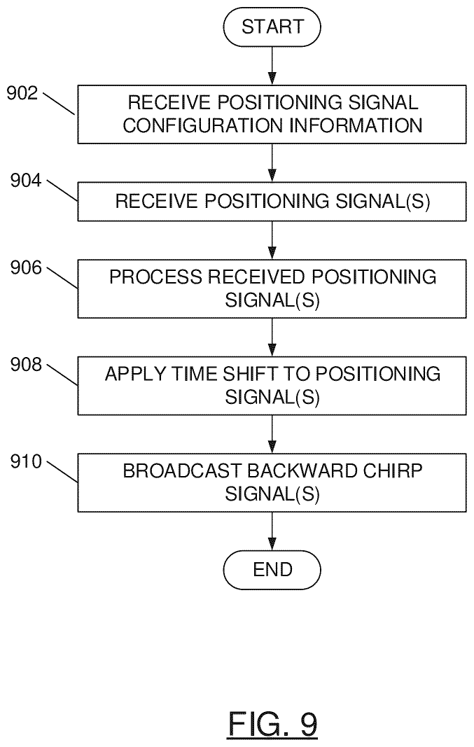

FIG. 9 illustrates example steps in a method of carrying out a positioning procedure at the target UE 606. The target UE 606 initially receives (step 902), from the SMF 176, positioning signal configuration information. Responsive to receiving (step 904) a forward chirp-based positioning signal, the target UE 606 may broadcast (step 910) a time-shifted reverse chirp-based positioning signal. The time-shifted reverse chirp signal may be understood to have the same parameters as the parameters of the forward chirp signal.

Responsive to receiving (step 904) more than one forward chirp-based positioning signal, the target UE 606 may broadcast (step 910) a plurality of time-shifted reverse chirp-based positioning signals, with one time-shifted reverse chirp-based positioning signal corresponding to each set of RX-AN nodes. Each time-shifted reverse chirp-based positioning signal may be expected to have the same parameters as the parameters of a corresponding one of the forward chirp-based positioning signals.

In the example illustrated in FIG. 6, the target UE 606 receives (step 904) a forward chirp-based positioning signal, c₁(t−τ₁^{F}), and processes (step 906) the forward chirp-based positioning signal. The processing (step 906) of the forward chirp-based positioning signal may be shown to allow the target UE 606 to associate, with the forward chirp-based positioning signal, a detected delay value, τ₁^{F}. One manner in which the target UE 606 may process (step 906) the forward chirp-based positioning signal involves subjecting the received forward chirp-based positioning signal to a matched filter (see FIG. 11).

The target UE 606 may then wait (step 908) a fixed amount of delay (a time shift) before broadcasting (step 910) the time-shifted reverse chirp-based positioning signal. Indeed, the fixed amount of delay may be shown to occur after a processing delay, τₚᵣ. In a case wherein the processing delay, τₚᵣ, is not negligible compared to the detected delay value, τ₁^{F}, the SMF 176 may set a fixed amount of delay that the target UE 606 may wait (step 908). This fixed amount of delay may be provided, by the SMF 176 to the target UE 606, as part of the providing (step 702), to all the terminals involved in the positioning process, positioning signal configuration information.

Notably, the method carried out by the target UE 606 (see FIG. 9) may be understood to include processing (step 906) the forward chirp-based positioning signal, where the processing (step 906) may involve both RF-processing and some limited digital processing. The RF-processing (step 906) may be shown to relate to, for example, matched filtering. The digital processing (step 906) may be shown to relate to detecting the peaks after the matched filtering in the case of multiple TX/RX-AN nodes and the waiting (step 908) the time shift before broadcasting (step 910) the time-shifted reverse chirp-based positioning signals. In some embodiments, the RF processing (step 906) may be shown to relate to, for example, de-chirping the received signal. De-chirping the received signal may be accomplished by multiplying the received signal by e^{-jπαt}^{²}. The digital processing (step 906) may be shown to relate to detecting the beat frequency of the de-chirped signal, e.g., by using an FFT operation.

An alternative way of implementing the time shift for reverse chirp-based positioning signals is by shifting in frequency. Due to the properties of a given chirp-based positioning signal, it may be shown that shifting in time is equivalent to shifting in frequency by the amount of −ατ₁^{F}.

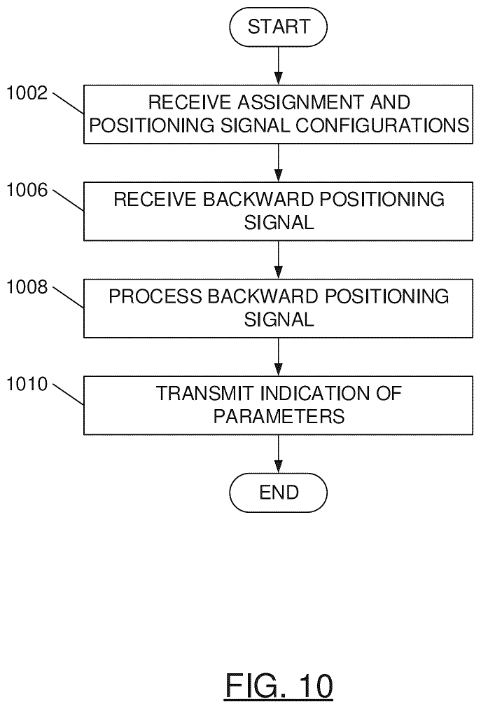

FIG. 10 illustrates example steps in a method of carrying out a positioning procedure at one of the RX-AN nodes 604-1, 604-2 (collectively or individually 604). The RX-AN node 604 initially receives (step 1002), from the SMF 176, an assignment along with positioning signal configuration information. Upon receiving (step 1006) a reverse chirp-based positioning signal from the target UE 606, the RX-AN node 604, may process (step 1008) the received reverse chirp-based positioning signal. Similarly, upon receiving (step 806) the reverse chirp-based positioning signal from the target UE 606, the TX/RX-AN node 602 may process (step 808) the received reverse chirp-based positioning signal. In aspects of the present application, the RX-AN node 604 may use a simple matched filter to process (step 1008) the received reverse chirp-based positioning signal to, thereby, detect a compound delay associated with the received reverse chirp-based positioning signal. Similarly, the TX/RX-AN node 602 may use a simple matched filter to process (step 808) the received reverse chirp-based positioning signal to, thereby, detect a compound delay associated with the received reverse chirp-based positioning signal.

Since the reverse chip signal is processed at the TX/RX-AN node 602 and at the RX-AN nodes 604-1, 604-2, according their respective clocks, and assuming that their respective clocks are synchronized with the network, the time of flight in the reverse direction may be

$${τ}_{j}^{R} = - Δ {t}_{j} + \frac{{d}_{j}^{R}}{c} ,$$

expressed as j=TX1, RX1, RX2, where dⱼ^{R} is representative of a distance between the receiver (TX/RX-AN 602, RX-AN 604-1, RX-AN 604-2) and the target UE 606 and c is representative of the speed of light. The compound delays may be understood to be a sum of the first delay in the forward direction, i.e., τ₁^{F} (see FIG. 6), and the different propagation delays in the reverse directions, i.e., τ_{TX1}^{R}, τ_{RX1}^{R} and τ_{RX2}^{R} (see FIG. 6). Consequently, the compound delay over the forward path and the reverse path may be expressed as

$${τ}_{1}^{F} + {τ}_{j}^{R} = \frac{{d}_{1}^{F} + {d}_{j}^{R}}{c} .$$

The detecting of the compound delay, by way of processing (step 1008 for the RX-AN node 604, step 808 for the TX/RX-AN node 602), may be shown to enable the estimation of a relative distance between the receiver carrying out the processing and the target UE 606 without TX-UE synchronization error in differential mode.

For a scenario with a set of RX-AN nodes with a number, M, of RX-AN nodes in the set, the relative distances between receivers, including the TX/RX-AN node, and the target UE 606 may be expressed as a list including 2d_{TX1}^{F}, d_{TX1}^{F}+d_{RX1}^{R}, d_{TX1}^{F}+d_{RX2}^{R}, . . . , d₁^{F}+d_{RXM}^{R}.

Notably, the compound delay value detected by the TX/RX-AN node 602 may be expressed as

$${τ}_{1}^{F} + {τ}_{1}^{R} = \frac{2 {d}_{1}^{F}}{C} .$$

Accordingly, it follows that the TX/RX-AN node 602 may, as part of the processing (step 808), directly estimate the distance, d₁^{F}, between the TX/RX-AN node 602 and the target UE 606. The distance values estimated, by the RX-AN nodes 604 as part of the processing (step 1008), may be understood to be compound distances that include the distance, d₁^{F}, between the TX/RX-AN node 602 and the target UE 606 and the distance, dⱼ^{F}, between the RX-AN node 604 and the target UE 606.

Upon completion of the processing (step 808) the received reverse chirp-based positioning signal, the TX/RX-AN node 602 may transmit (step 810), to the SMF 176, an indication of parameters of the reverse chirp-based positioning signal, including the estimated distance, d₁^{F}. Similarly, upon completion of the processing (step 1008) the received reverse chirp-based positioning signal, the RX-AN nodes 604 may transmit (step 1010), to the SMF 176, an indication of parameters of the reverse chirp-based positioning signal, including the estimated compound distance, d₁^{F}+dⱼ^{R}.

The SMF 176 may receive (step 706) the indication of the parameters, including an indication of the estimated distance, d₁^{F}, and the indications of the estimated compound distances, d₁^{F}+dⱼ^{R}. The SMF 176 may then process (step 708) the parameters to obtain position information for the target UE 606. Recall that the target UE 606 remains in low power mode. Indeed, it should be clear that the SMF 176 may use the estimated distance, d₁^{F}, in combination with the estimated compound distances, d₁^{F}+dⱼ^{R}, to determine the unknown distances, dⱼ^{R}.

In the event the SMF 176 is co-located with any other network node (e.g., the TX/RX-AN node 602, the first RX-AN node 604-1, or the second RX-AN node 604-2), appropriate modifications to the transmissions and receptions in the methods of FIGS. 7-10 may be implemented and apparent to persons skilled in the art.

Aspects of the present application relate to positioning procedures for UEs in extremely low power modes. As discussed hereinbefore, the extremely low power modes may be distinguished as a “class A” extremely low power mode and a “class B” extremely low power mode. In particular, aspects of the present application relate to managing to position and synchronize a given UE in an extremely low power (ELP) mode without the given ELP-UE turning on TX RF circuitry. TX RF circuitry is typically turned on to transmit RF signals with regular transmit powers and ranges. Aspects of the present application promote use of backscattering communications to create the reverse chirp-based positioning signal. In these aspects of the present application, the receiver of the reverse chirp-based positioning signal is not the transmitter of the forward chirp-based positioning signal, as was the case for the TX/RX-AN 602 hereinbefore. The anchor nodes in these aspects of the present application may either be the transmitter (TX-AN node) or the receiver (RX-AN node) of the chirp-based positioning signal. Moreover, the RX-AN nodes may be selected from among connected UEs and network nodes in the proximity of the target ELP-UE so that their respective distances away from the target ELP-UEs are small enough to allow for reliable reception, at the RX-AN nodes, of backscattered chirp-based positioning signals. This is in contrast to aspects of the present application presented hereinbefore, where the RX-AN nodes are possibly relatively far away from the target UE 606, since the target UE 606 has the ability to transmit with regular power.

Aspects of the present application relate to allowing ELP-UEs to embed, in a reverse chirp-based positioning signals, a unique RF signature. The embedding may be accomplished by shifting, in frequency, a particular time-part of the forward chirp-based positioning signals. The shifting may be shown to make the reverse chirp-based positioning signals appear, at a receiver, as two chirp-based positioning signals with two different starting frequencies and two different periods but with the same chirp rate. The two chirp-based positioning signals may be used, at the receiver, to obtain information about ELP-UE position and information about TX-UE synchronization error.

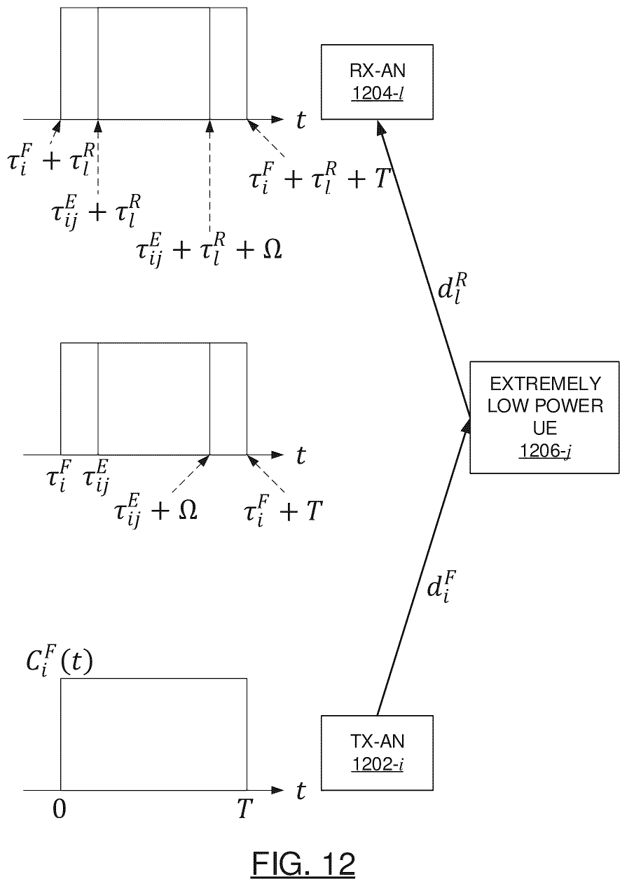

FIG. 12 illustrates an i^{th} TX-AN node 1202-i, a j^{th} ELP-UE 1206-j and an l^{th} RX-AN node 1204-l. The j^{th} ELP-UE 1206-j is understood to be in class B extremely low power mode. FIG. 12 illustrates that the i^{th} TX-AN node 1202-i transmits a chirp-based forward chirp-based positioning signal, Cᵢ^{F}(t), between t=0 and t=T, with a chirp rate, α, and a bandwidth, B. According to aspects of the present application, the j^{th} ELP-UE 1206-j may apply an RF-domain signature by frequency shifting the forward chirp-based positioning signal, Cᵢ^{F}(t), by a frequency shift, fⱼ, such that a reverse chirp-based positioning signal, Cᵢⱼ^{R}(t), emanates from the j^{th} ELP-UE 1206-j. The reverse chirp-based positioning signal, Cᵢⱼ^{R}(t), may be expressed as Cᵢⱼ^{R}(t)=Cᵢ^{F}(t)e^{-j2πf}^{ⱼ}^{t}. The signature may be applied, at the j^{th} ELP-UE 1206-j, in a range of time extending from τᵢⱼ^{E} to τᵢⱼ^{E}+Ω, with respect to timing of the i^{th} TX-AN node 1202-i. The range is defined to include a period, Ω, for the application of the signature, fⱼ.

A starting time instance, tⱼ*, may be representative of a time instance at which the j^{th} ELP-UE 1206-j has been preconfigured to start applying its signature. The term, τᵢⱼ^{E}, in the range of time over which the signature may be applied may be referenced as a “corrected starting time.” Indeed, the corrected starting time, τᵢⱼ^{E}, may be defined as τᵢⱼ^{E}=tⱼ*+Δt_{ij,TX-UE}, where Δt_{ij,TX-UE} denotes a time offset (also called “the TX-UE synchronization error”) between a clock at the j^{th} ELP-UE 1206-j and a clock at the i^{th} TX-AN node 1202-i.

Notably, the time instance, tⱼ*, may be preconfigured to be larger than a largest propagation delay. Furthermore, the time instance, tⱼ*, may be preconfigured to be larger than a timing offset between devices in given area or larger than a timing offset permitted for a predetermined set of applications. Even further, the time instance, tⱼ*, may be preconfigured to be smaller than a sum of a smaller delay and the period, T.

The signature, fⱼ, for the j^{th} ELP-UE 1206-j may be configured to be unique among a plurality of ELP-UEs (not shown in FIG. 12). Accordingly, the signature, fⱼ, for the j^{th} ELP-UE 1206-j may be mapped to an ELP-UE identity (an “ELP-UE ID”) such that, by detecting the signature, fⱼ, a receiver of parameters of the reverse chirp-based positioning signal, which may be the SMF 176, may obtain the identity of the j^{th} ELP-UE 1206-j.

The l^{th} RX-AN node 1204-l may apply analog RF chirp compression (e.g., implemented as a matched filter) with a chirp rate, α. Application of the analog RF chirp compression may be shown to allow the l^{th} RX-AN node 1204-l to obtain a compound delay, τᵢ^{F}+τᵢ^{R}. The l^{th} RX-AN node 1204-l may process the compound delay to obtain a compound distance, dᵢ^{F}+dₗ^{R}, from the i^{th} TX-AN node 1202-i to the j^{th} ELP-UE 1206-j and from the j^{th} ELP-UE 1206-j to the l^{th} RX-AN node 1204-l. The l^{th} RX-AN node 1204-l may process the received chirp-based positioning signal to obtain a compound delay, τᵢⱼ^{E}+τₗ^{R}, which may be shown to provide an indication of a timing offset between the j^{th} ELP-UE 1206-j and the i^{th} TX-AN node 1202-i. The l^{th} RX-AN node 1204-l may process the received chirp-based positioning signal to obtain the signature, fⱼ, of the j^{th} ELP-UE 1206-j. From the signature, fⱼ, the l^{th} RX-AN node 1204-l may obtain an ELP-UE ID for the j^{th} ELP-UE 1206-j. As will be discussed hereinafter, these parameters (three bits of information: the compound distance; the compound delay; and the ELP-UE ID) may be employed, by the SMF 176, to obtain an accurate position for the j^{th} ELP-UE 1206-j and remove the ambiguity about synchronization.

Aspects of the present application relate to a positioning procedure for an ELP-UE in the class B extremely low power mode.

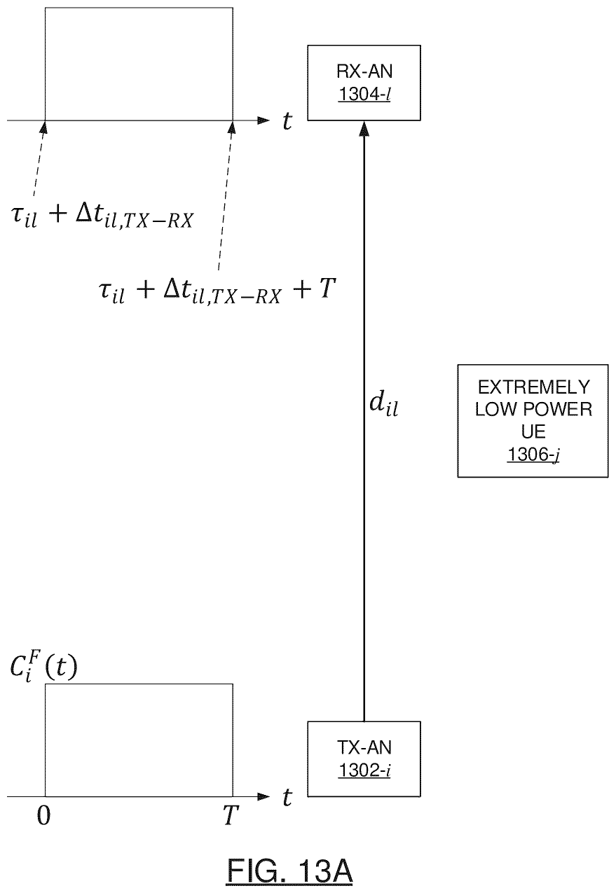

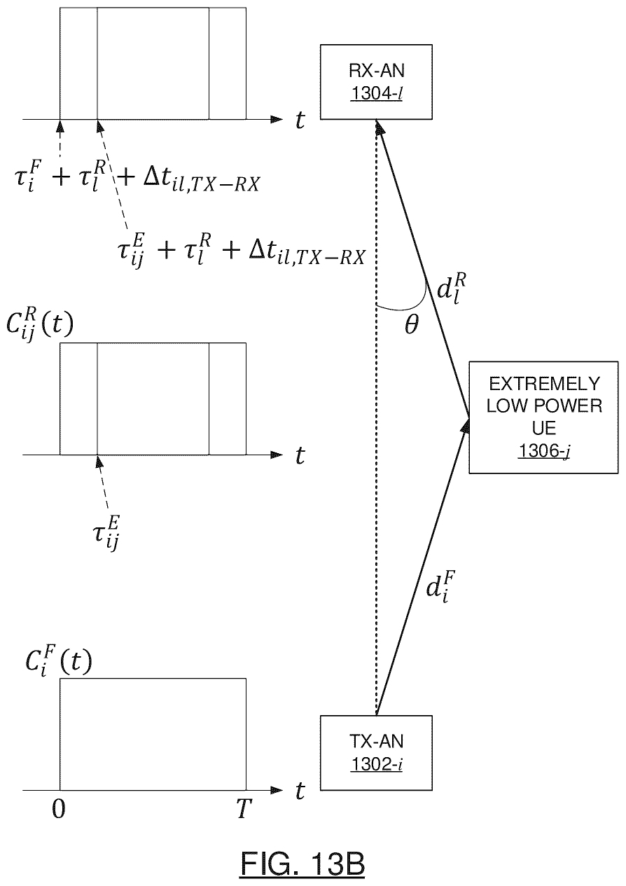

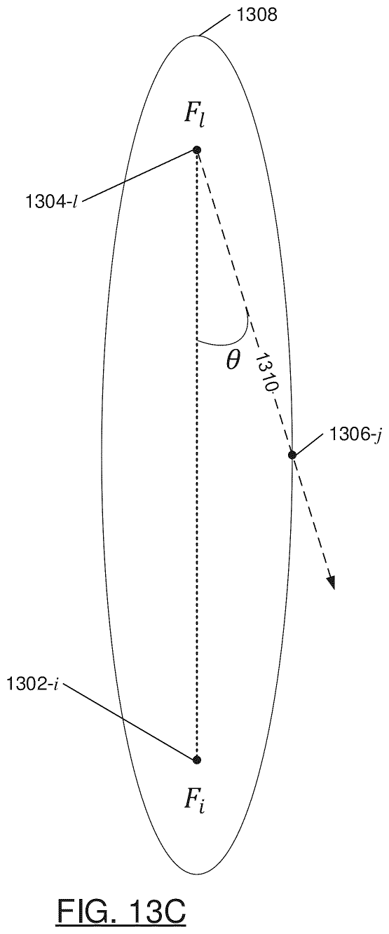

FIG. 13A illustrates an i^{th} TX-AN node 1302-i, a j^{th} ELP-UE 1306-j and an l^{th} RX-AN node 1304-l. The j^{th} ELP-UE 1306-j is understood to be in class B extremely low power mode. Due to limited power, such ELP-UEs are not configured to generate and transmit positioning signals in the reverse direction, this positioning procedure is subjected to some constraints. The constraints include only using RX-AN nodes in relatively close proximity to the ELP-UEs, since these are the only nodes that can be expected to reliably receive backscattered chirp-based positioning signals from the ELP-UEs. This constraint might limit the possibility of finding RX-ANs that are relatively tightly synchronized with TX-AN nodes. Consequently, this positioning procedure may be understood to take into consideration various synchronization errors between ELP-UEs and RX-AN nodes and between ELP-UEs and TX-AN nodes.

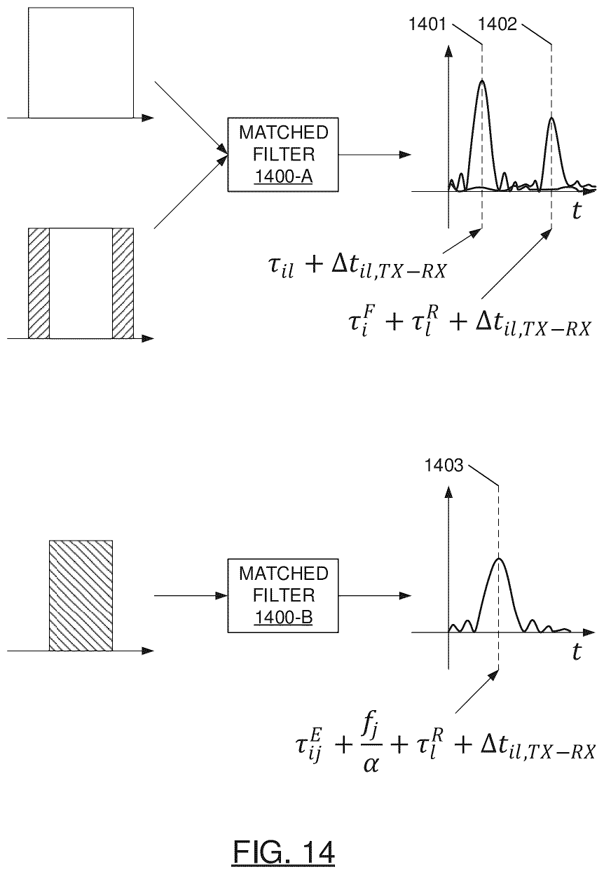

This positioning procedure is initialized when, in view of FIG. 13A, the i^{th} TX-AN node 1302-i transmits a chirp-based forward positioning signal, Cᵢ^{F}(t), between t=0 and t=T, with a chirp rate, α, and a bandwidth, B. Upon receipt and processing of the forward chirp-based positioning signal, Cᵢ^{F}(t), the l^{th} RX-AN node 1304-l, among a plurality of RX-AN nodes (not shown in FIG. 13A), may process the forward chirp-based positioning signal, Cᵢ^{F}(t). FIG. 14 illustrates a first matched filter 1400-A that may be used by the l^{th} RX-AN node 1304-l. The processing of the forward chirp-based positioning signal, Cᵢ^{F}(t), by the l^{th} RX-AN node 1304-l using the first matched filter 1400-A, may allow the l^{th} RX-AN node 1304-l to detect a first peak 1401 at τᵢₗ+Δt_{il,TX-RX}, where a delay,

$${τ}_{il} = \frac{{d}_{il}}{c} ,$$

may be understood to correspond to a time for the forward chirp-based positioning signal, Cᵢ^{F}(t), to traverse a line-of-sight (LOS) link between the i^{th} TX-AN node 1302-i and the l^{th} RX-AN node 1304-l and where Δt_{il,TX-RX} denotes a relative timing offset between the i^{th} TX-AN node 1302-i and the l^{th} RX-AN node 1304-l.

It may be expected that the j^{th} ELP-UE 1306-j may backscatter the forward chirp-based positioning signal to, thereby, create a backscattered, reverse chirp-based positioning signal, Cᵢⱼ^{R}(t) (see FIG. 13B). Processing of the reverse chirp-based positioning signal, Cᵢⱼ^{R}(t), through use, for example, of the first matched filter 1400-A, may be shown to allow the l^{th} RX-AN node 1304-l to detect a second peak 1402 (see FIG. 14) at τᵢ^{F}+τₗ^{R}+Δt_{il,TX-RX}. The second peak 1402 may be understood to correspond to a first part of the backscattered, chirp-based reverse positioning signal, Cᵢⱼ^{R}(t).

The processing of the reverse positioning signal, Cᵢⱼ^{R}(t), through use, for example, of a second matched filter 1400-B (see FIG. 14), may allow the l^{th} RX-AN node to detect a third peak 1403 at

$${τ}_{ij}^{E} + \frac{{f}_{j}}{α} + {τ}_{l}^{R} + Δ {t}_{il , TX - RX} .$$

The third peak 1403 may be understood to correspond to a second part of the reverse positioning signal, Cᵢⱼ^{R}(t), received from the j^{th} ELP-UE 1306-j. The second part of the reverse positioning signal, Cᵢⱼ^{R}(t), may be understood to be the part that includes the signature, fⱼ.

It may be demonstrated that these three peaks 1401, 1402, 1403 may be detected reliability at a variety of RX-AN nodes, where the three peaks 1401, 1402, 1403 are largely separated in signal strength (amplitude) and frequency. In particular, the first peak may be shown to be much stronger than the other two peaks, since the signal that corresponds to the first peak propagates the least distance from the i^{th} TX-AN node. Additionally, the third peak may be shown to have much higher frequency components, due to the applied signature, fⱼ. The application of the signature may be translated to a relatively large time delay,

$$\frac{{f}_{j}}{α} ,$$

after compression/matched filtering.

Consequently, the total signal received at the l^{th} RA-AN node 1304-l due to transmission of the chirp-based positioning signal, Cᵢ^{F}(t), may be considered to be a superposition of three chirp-based positioning signals, where each chirp-based positioning signal has the same chirp rate but with different delays and amplitudes. The detection of these three chirp-based positioning signals may be accomplished, as illustrated in FIG. 14, using the two matched filters 1400-A, 1400-B. The first matched filter 1400-A may be used to detect the first two chirp-based positioning signals, i.e., the LOS chirp-based positioning signal and the first part of the backscattered chirp-based positioning signal, which has no ELP-UE signature. The second matched filter 1400-B may be used to detect the part of the backscattered chirp-based positioning signal that has the ELP-UE signature.

Using the first matched filter 1400-A, the l^{th} RX-AN node 1304-l may detect the first peak 1401, at τᵢₗ+Δt_{il,TX-RX}. Based on the detecting, the l^{th} RX-AN node 1304-l may obtain an estimate for a TX-RX synchronization error, Δt_{il,TX-RX}, between the l^{th} RX-AN node 1304-l and the i^{th} TX-AN node 1302-i. This estimate may be obtained based on foreknowledge of a distance, dᵢₗ, between the i^{th} TX-AN node 1302-i and the l^{th} RX-AN node 1304-l, i.e., dᵢₗ=∥Fᵢ−Fₗ∥, where Fᵢ is representative of a location for the i^{th} TX-AN node 1302-i and Fₗ is representative of a location for the l^{th} RX-AN node 1304-l. The l^{th} RX-AN node 1304-l may use the distance, du, to estimate the LOS delay, Ta. It follows that the l^{th} RX-AN node 1304-l may estimate the TX-RX synchronization error, Δt_{il,TX-RX}, by subtracting the estimated LOS delay, τᵢₗ, from the detected location of the first peak 1401, which is understood to be detected at τᵢₗ+Δt_{il,TX-RX}.

Using the first matched filter 1400-A, the l^{th} RX-AN node 1304-l may detect the second peak 1402, at τᵢ^{F}+τₗ^{R}+Δt_{il,TX-RX}. Based on having previously obtained an estimate for the TX-RX synchronization error, Δt_{il,TX-RX}, the l^{th} RX-AN node 1304-l may obtain an estimate for a compound time of flight, τᵢ^{F}+τₗ^{R}. The compound time of flight may be understood to represent an i^{th} time of flight, τᵢ^{F}, from the i^{th} TX-AN node 1304-i to the j^{th} ELP-UE 1306-j summed with an l^{th} time of flight, τₗ^{R}, from the j^{th} ELP-UE 1306-j to the RX-AN node 1304-l. From the estimate for the compound time of flight, τᵢ^{F}+τₗ^{R}, the l^{th} RX-AN node 1304-l may obtain an estimate for a compound distance, dᵢ^{F}+dₗ^{R}. The compound distance may be understood to be an i^{th} distance, dᵢ^{F}, from the i^{th} TX-AN node 1304-i to the j^{th} ELP-UE 1306-j summed with an l^{th} distance, dₗ^{R}, from the j^{th} ELP-UE 1306-j to the l^{th} RX-AN node 1304-l.

Recall that an ellipse may be defined such that each given point on the contour of the ellipse has a sum of distances to two focus points in common with all the other points on the contour of the ellipse. It follows that the l^{th} RX-AN node 1304-l may define an ellipse 1308 (see FIG. 13C) on the basis of the compound distance, dᵢ^{F}+dₗ^{R}, and using the locations, (Fᵢ, Fₗ), of the i^{th} TX-AN node 1304-i and the l^{th} RX-AN node 1304-l as the two focus points of the ellipse 1308. The j^{th} ELP-UE 1306-j may be expected to be at a location on the ellipse defined in this manner. If a plurality of RX-AN nodes each detect the forward and reverse positioning signals, the position of the j^{th} ELP-UE 1306-j may be estimated by finding an intersection of a corresponding plurality of ellipses, with one ellipse defined for each RX-AN node among the plurality of RX-AN nodes.

The value detected for the third peak 1403 may be considered to be a sum of four terms,

$${τ}_{ij}^{E} + \frac{{f}_{j}}{α} + {τ}_{l}^{R} + Δ {t}_{il , TX - RX} .$$

Conveniently, as described hereinbefore, an estimate may have already been obtained for two of the terms: the TX-RX synchronization error, Δt_{il,TX-RX}, and the time-shift,

$$\frac{{f}_{j}}{α} .$$

On the basis or subtracting, from the value detected for the third peak 1403, the estimates that have already been obtained for the two terms, the l^{th} RX-AN node 1304-l may obtain an estimate for a received signal offset, τᵢⱼ^{E}+τₗ^{R}. By neglecting the term, τₗ^{R}, for the time of flight from the j^{th} ELP-UE 1306-j to the l^{th} RX-AN node 1304-l, the l^{th} RX-AN node 1304-l may obtain a rough estimate for the corrected starting time, τᵢⱼ^{E}. In view of the estimate for the corrected starting time, τᵢⱼ^{E}, and the preconfigured time instance, tⱼ*, the l^{th} RX-AN node 1304-l may obtain an estimate for a difference, τᵢⱼ^{E}−tⱼ*, between these two terms.

Recall that the corrected starting time, τᵢⱼ^{E}, has been defined as a sum, τᵢⱼ^{E}=tⱼ*+Δt_{ij,TX-UE}, of the preconfigured time instance, tⱼ*, and the TX-UE synchronization error, Δt_{ij,TX-UE}. Accordingly, the difference, τᵢⱼ^{E}−tⱼ*, may be considered to be an estimate of an upper bound for the TX-UE synchronization error, Δt_{ij,TX-UE}. Indeed, since the rough estimate for the corrected starting time, τᵢⱼ^{E}, is, more accurately, an estimate of a received signal offset, τᵢⱼ^{E}+τₗ^{R}, the estimate of the TX-UE synchronization error, Δt_{ij,TX-UE}, may be shown to rely upon use of a relationship, τᵢⱼ^{E}+τₗ^{R}=tⱼ*+Δt_{ij,TX-UE}, which relationship may be restated, in terms of the estimated difference, as τᵢⱼ^{E}−tⱼ*=Δt_{ij,TX-UE}−τₗ^{R}. Use of the estimated difference, as τᵢⱼ^{E}−tⱼ*, as an estimate for the TX-UE synchronization error, Δt_{ij,TX-UE}, may be considered reasonable for those situations in which to τₗ^{R}<<τᵢⱼ^{E}. In general, situations in which τₗ^{R}<<τᵢⱼ^{E} may be considered to be common when using backscattering of forward positioning signals, due the limited range of backscattering communications.

The l^{th} RX-AN node 1304-l may transmit (step 1010, FIG. 10), to the SMF 176, parameters including the estimated sum of distances, dᵢ^{F}+dₗ^{R}, as well as an estimate for the TX-UE synchronization error, Δt_{ij,TX-UE}, and the signature, fⱼ. Responsive to receiving (step 706, FIG. 7) values for these parameters, the SMF 176 may determine a set of RX-AN nodes reporting values for the parameters related to the same signature, fⱼ. Accordingly, the SMF 176 may jointly process (step 708, FIG. 7) the values for the parameters to, thereby, obtain a location for the j^{th} ELP-UE 1206-j associated with the signature, fⱼ.

Obtaining the position of the j^{th} ELP-UE 1206-j may be shown to be possible, even by the single RX-UE node 1304-l, under a condition that some angle-based measurements can be carried out at the l^{th} RX-AN node 1304-l. Indeed, the l^{th} RX-AN node 1304-l may perform angle of arrival (AoA) detection for the LOS forward positioning signal and AoA detection for the reverse positioning signal. The l^{th} RX-AN node 1304-l may then determine a relative angle, θ, between the forward chirp-based positioning signal and the reverse chirp-based positioning signal. The location of the j^{th} ELP-UE 1206-j may be considered to be located at the intersection between a ray 1310 (see FIG. 13C) emanating from the l^{th} RX-AN node 1304-l at θ degrees and the ellipse 1308 defined using the compound distance, dᵢ^{F}+dₗ^{R}, the location, Fᵢ, of the i^{th} TX-AN node 1202-i and the location, Fₗ, of the l^{th} RX-AN node 1304-l.

Aspects of the present application relate to a second class B positioning procedure for an ELP-UE in the class B extremely low power mode. This second class B positioning procedure may be shown to have a reduced computational complexity at the cost of relying upon a tight synchronization between a given RX-AN node and the corresponding TX-AN node.

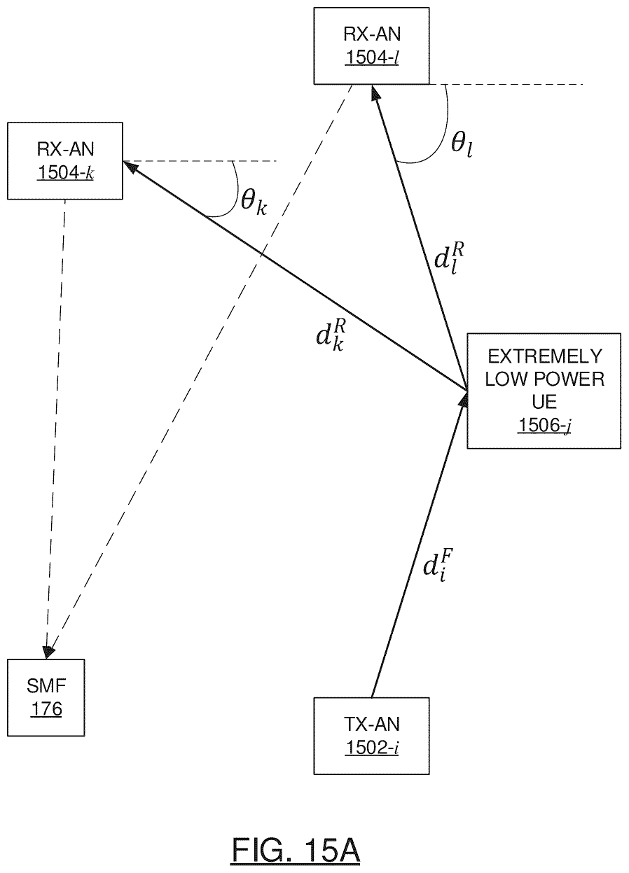

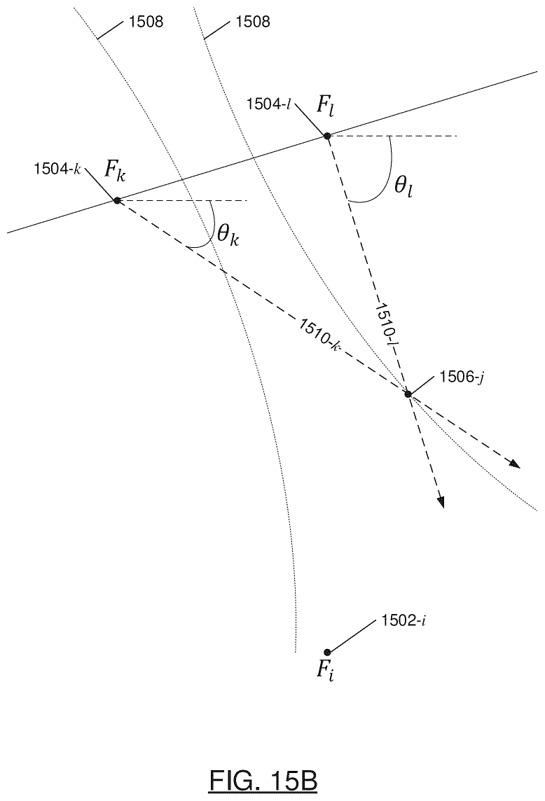

A scenario is illustrated in FIG. 15A to include an i^{th} TX-AN node 1502-i, an l^{th} RX-AN node 1504-l, a k^{th} RX-AN node 1504-k and a j^{th} ELP-UE 1506-j.

Towards a goal of saving some computational complexity at RX-AN nodes 1504, the second class B positioning procedure utilizes only the part of the backscattered chirp-based positioning signal that includes the signature of the j^{th} ELP-UE 1506-j. An estimation of

$$\frac{{f}_{j}}{α} + {τ}_{ij}^{E} + {τ}_{l}^{R}$$

may be obtained, at the l^{th} RX-AN node 1504-1, by only processing the part of the backscattered chirp-based positioning signal that includes the signature of the j^{th} ELP-UE 1506-j. The approach of the second class B positioning procedure may be shown to reduce computational complexity due to a relatively large frequency separation. Additionally, it can be seen that the second class B positioning procedure involves only detecting one peak, in contrast to the first class B positioning procedure, described hereinbefore, that involves detecting three peaks.

In operation, the i^{th} TX-AN node 1502-i transmits a forward chirp-based positioning signal. The j^{th} ELP-UE 1506-j backscatters the forward chirp-based positioning signal while applying, to the forward chirp-based positioning signal, a signature, fⱼ. The l^{th} RX-AN node 1504-l and the k^{th} RX-AN node 1504-k receive the backscattered chirp-based positioning signal. The l^{th} RX-AN node 1504-l may use matched filtering to estimate, that is, find a peak located at,

$$\frac{{f}_{j}}{α} + {τ}_{ij}^{E} + {τ}_{l}^{R} .$$

Given a sufficiently large signature, fⱼ, the l^{th} RX-AN node 1504-l may obtain a value for the signature, fⱼ, as well as a value for an l^{th} received signal offset,

$${δ}_{l} {=}^{Δ} {τ}_{ij}^{E} + {τ}_{l}^{R} .$$

The l^{th} RX-AN node 1204-l may also measure an l^{th} AoA, θₗ, for the backscattered positioning signal. In a similar manner, the k^{th} RX-AN node 1204-k may obtain values for the signature, fⱼ, a k^{th} received signal offset,

$${δ}_{k} {=}^{Δ} {τ}_{ij}^{E} + {τ}_{k}^{R} ,$$

and a k^{th} AOA, θₖ.

The l^{th} RX-AN node 1204-l may transmit (step 1010, FIG. 10), to the SMF 176, a set of parameters, including indications for the values of the signature, fⱼ, the l^{th} received signal offset, δₗ, and the l^{th} AoA, θₗ. The k^{th} RX-AN node 1204-k may also transmit (step 1010, FIG. 10), to the SMF 176, a set of parameters, including indications for the values of the signature, fⱼ, the k^{th} received signal offset, δₖ, and the k^{th} AoA, θₖ.

The SMF 176 may identify, based the respective values for the signature, fⱼ, that the set of parameters received (step 706, FIG. 7) from the l^{th} RX-AN node 1204-l and the set of parameters received (step 706, FIG. 7) from the k^{th} RX-AN node 1204-k correspond to the same ELP-UE, i.e., the j^{th} ELP-UE 1206-j. The SMF 176 may (step 708, FIG. 7) the received parameters to determine a received signal offset difference between the two received signal offsets, δₖ and δₗ. The SMF 176 may then obtain, from the received signal offset difference, a time difference, τₖ^{R}−τₗ^{R}. Obtaining the time difference, τₖ^{R}−τₗ^{R}, may be shown to cancel the impact of the corrected starting time, τᵢⱼ^{E}. Recall that the corrected starting time, τᵢⱼ^{E}, is present in definitions of both the l^{th} received signal offset, δₗ, and the k^{th} received signal offset, δₖ. On the basis of the time difference, τₖ^{R}−τₗ^{R}, the SMF 176 may determine a distance difference, dₖ^{R}−dₗ^{R}. Given the distance difference, dₖ^{R}-dₗ^{R}, the position of the j^{th} ELP-UE 1206-j may be shown to be on a hyperbola 1508 (see FIG. 15B) defined with two focus points: a focus point located at a position, Fₗ, for the l^{th} RX-AN node 1204-l; and a focus point located at a position, Fₖ, for the k^{th} RX-AN node 1204-k.

An estimated position for the j^{th} ELP-UE 1206-j may be obtained, by the SMF 176, as the intersection of the hyperbola 1508, an l^{th} ray 1510-l originating at the l^{th} RX-AN node 1204-l with the l^{th} AoA, θₗ, and a k^{th} ray 1510-k originating at the k^{th} RX-AN node 1204-k with the k^{th} AoA, θₖ.

The second class B positioning procedure can be extended for scenarios with more than two RX-AN nodes and more than one TX-AN nodes. Increasing the number of anchor nodes may be shown to improve accuracy for the estimated position for the j^{th} ELP-UE 1506-j.

Aspects of the present application relate to a positioning procedure for an ELP-UE in the class A extremely low power mode.

The class A positioning procedure is tailored for ELP-UEs that cannot afford to transmit a signal with regular power and with regular ranges. However, these ELP-UEs are understood to be able to afford to process received signals using analog RF processing and a limited amount of digital processing before reflecting the processed signals using backscattering-based receivers. Particularly, this class A positioning procedure may be shown to increase accuracy for ELP-UEs positioning, relative to many of the previously discussed positioning procedures, at the cost of higher power consumption, due to the extra digital processing.

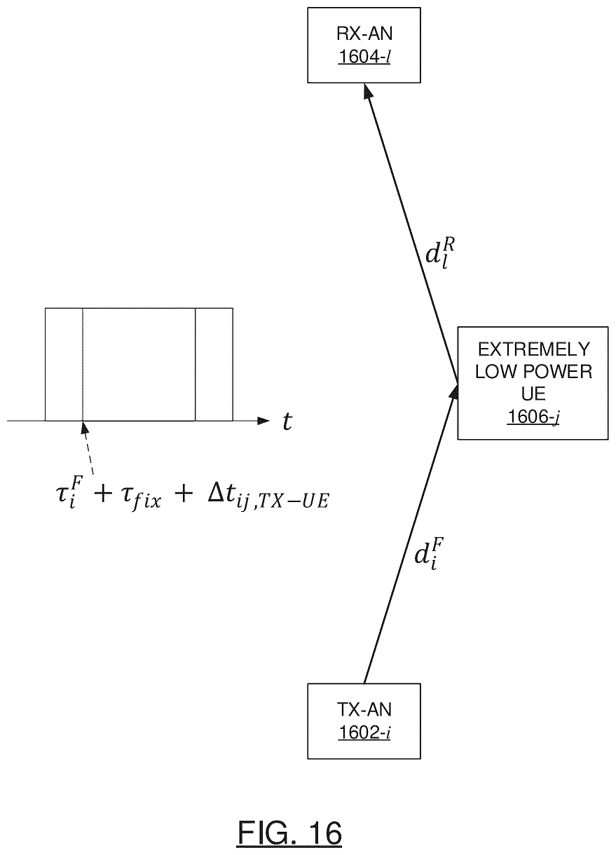

A scenario is illustrated in FIG. 16 to include an i^{th} TX-AN node 1602-i, an l^{th} RX-AN node 1604-l and a j^{th} ELP-UE 1606-j.

A starting time instance, tⱼ*, may be representative of a time instance at which the j^{th} ELP-UE 1606-j has been preconfigured to start applying its signature.

The starting time instance, tⱼ*, may be defined in reference to a clock (or a time frame) at the i^{th} TX-AN node 1602-i. Notably, in this aspect of the present application, the time instance, t′, may be defined based on a forward time of flight, τᵢ^{F}, measured at the j^{th} ELP-UE 1606-j, for a positioning signal transmitted by the i^{th} TX-AN node 1602-i. Particularly, the j^{th} ELP-UE 1606-j may be configured to apply its signature after a predefined, fixed delay, τ_{fix}, which may be measured from the time of flight, τᵢ^{F}. The time instant at which the j^{th} ELP-UE 1606-j commences applying the signature may be expressed as τᵢ^{F}+τ_{fix} with respect to a clock that is internal to the j^{th} ELP-UE 1606-j. The time instant at which the j^{th} ELP-UE 1606-j commences applying the signature may be expressed as τᵢ^{F}+τ_{fix}+Δt_{ij,TX-UE} with respect to a clock that is internal to the i^{th} TX-AN node 1602-i. It follows that a corrected starting time, τᵢⱼ^{E}, may be estimated as τᵢⱼ^{E}=τᵢ^{F}+τ_{fix}+Δt_{ij,TX-UE}. Recall that, in an aspect of the present application, the corrected starting time, τᵢⱼ^{E}, was defined as τᵢⱼ^{E}=tⱼ*+Δt_{ij,TX-UE}, with the starting time, tⱼ*, being preconfigured.

The modification, from τᵢⱼ^{E}=tⱼ*+Δt_{ij,TX-UE} to τᵢⱼ^{E}=τᵢ^{F}+τ_{fix}+Δt_{ij,TX-UE}, may be shown to allow the j^{th} ELP-UE 1606-j to detect the time at which the chirp-based positioning signal, transmitted (step 804, FIG. 8) by the i^{th} TX-AN node 1602-i, has been received. That is, the j^{th} ELP-UE 1606-j is allowed to estimate time of flight, τᵢ^{F}. The task of estimating time of flight, τᵢ^{F}, may be shown to employ limited digital processing in addition to RF analog processing. It follows that power consumption may be shown to be higher for this class A positioning procedure than the power consumption associated with those class B positioning procedures that do not involve any digital processing.

Conveniently, by allowing the j^{th} ELP-UE 1606-j to estimate the i^{th} time of flight, τᵢ^{F}, the l^{th} RX-AN node 1604-l, and any other RX-AN nodes (not shown), may be allowed to estimate the TX-UE synchronization error, Δt_{ij,TX-UE}, between the j^{th} ELP-UE 1606-j and the i^{th} TX-AN node 1602-i. Recall that, in aspects of the present application presented hereinbefore, the TX-UE synchronization error, Δt_{ij,TX-UE}, has been approximated. In particular, recall that an upper bound on a value of the TX-UE synchronization error, Δt_{ij,TX-UE}, may be approximated on the basis of having determined an estimated difference, τᵢⱼ^{E}−tⱼ*, and considering that the difference is representative of an estimate for another difference, Δt_{ij,TX-UE}−τₗ^{R}. It may be considered that this difference may be simplified to the TX-UE synchronization error, Δt_{ij,TX-UE}, in those situations for which τₗ^{R}<<Δt_{ij,TX-UE}. This simplification may be justified on the basis of backscattering communication having a limited range. That is, the distance, dₗ^{R}, from the j^{th} ELP-UE 1606-j to the l^{th} RX-AN node 1604-l may be considered to be relatively small and, as a result, the time of flight, τₗ^{R}, over the distance, dₗ^{R}, may also be considered to be relatively small.

The estimation of the TX-UE synchronization error, Δt_{ij,TX-UE}, at the l^{th} RX-AN node 1604-l may be accomplished based on detecting three peaks. As discussed hereinbefore, the three peaks may be detected at Δt_{il,TX-RX}, τᵢ^{F}+τₗ^{R}+Δt_{il,TX-RX} and τᵢⱼ^{E}+τₗ^{R}+Δt_{il,TX-RX}.

The relationship τᵢⱼ^{E}=τᵢ^{F}+τ_{fix}+Δt_{ij,TX-UE} was introduced hereinbefore to relate the corrected starting time to three terms, where only one of the terms, τ_{fix}, is known at the l^{th} RX-AN node 1604-l. This relationship may be rearranged as τᵢⱼ^{E}−τᵢ^{F}=τ_{fix}+Δt_{ij,TX-UE}.

By subtracting the value detected for the second peak, τᵢ^{F}+τₗ^{R}+Δt_{il,TX-RX}, from the value detected for the third peak, τᵢⱼ^{E}+τₗ^{R}+Δt_{il,TX-RX}, the l^{th} RX-AN node 1604-l may obtain a value for a difference, τᵢⱼ^{E}−τᵢ^{F}. As discussed hereinbefore, this difference may be related to the TX-UE synchronization error, Δt_{ij,TX-UE}, by the relationship τᵢⱼ^{E}−τᵢ^{F}=τ_{fix}+Δt_{ij,TX-UE}, where the term, τ_{fix}, is representative of a predefined, fixed delay. Accordingly, the l^{th} RX-AN node 1604-l may obtain an estimate for the TX-UE synchronization error, Δt_{ij,TX-UE}, by subtracting the predefined, fixed delay, τ_{fix}, from the obtained difference, τᵢⱼ^{E}−τᵢ^{F}.

Aspects of the present application relate to a manner by which the SMF 176 may obtain positioning information for a plurality of target UEs with different power capabilities in a given serving area. In aspects of the present application presented hereinbefore, the SMF 176 may be configured to obtain positioning information for a plurality of target UEs that all have the same power capabilities. The power capabilities are defined as either low power or extremely low power. In the case of low power mode target UEs, it has been discussed that the SMF 176 may assign distinct starting frequencies, fᵢ, to distinct TX-AN nodes. In the case of extremely low power mode target UEs, it has been discussed that the SMF 176 may assign distinct signatures, fᵢ, to distinct target UEs.

Since serving low power mode target UEs involves configuring TX-AN nodes and serving extremely low power mode target UEs involves configuring the target UEs, it may be shown that serving target UEs, within a certain area, that have a mix of power capabilities is somewhat complex. The complexity may be considered to be derived from a likelihood that a plurality of chirp-based positioning signals, received at a given receiver, might interfere with one another when the chirp-based positioning signals are related the task of determining position of target UEs having different power capabilities.

Aspects of the present application are related to appropriate handling of spatial separation of anchors, in addition to frequency, time and slope separation. It should be well understood that positioning signals emanating from a low power UE and positioning signals emanating from an extremely low power (ELP) UE have two different ranges. Positioning signals that can be received by an RX-AN node configured for receiving positioning signals emanating from an ELP-UE have a low probability of interfering with positioning signals that can be received by an RX-AN node configured for receiving positioning signals emanating from an LP-UE. However, positioning signals that can be received by an RX-AN node configured for receiving positioning signals emanating from an LP-UE have high probability of interfering with positioning signals that can be received by an RX-AN node configured for receiving positioning signals emanating from an ELP-UE. It follows that it is advisable to utilize a relatively wide separation in time and/or frequency between positioning signals that are to emanate from ELP-UEs and positioning signals are to emanate from LP-UEs, at least in the proximity of LP-UEs. Notably, differences in chirp rate may be regarded as unlikely to lead to complete orthogonality.

Aspects of the present application address this complexity by configuring the chirp-based positioning signals to be distinguishable at the intended receivers.

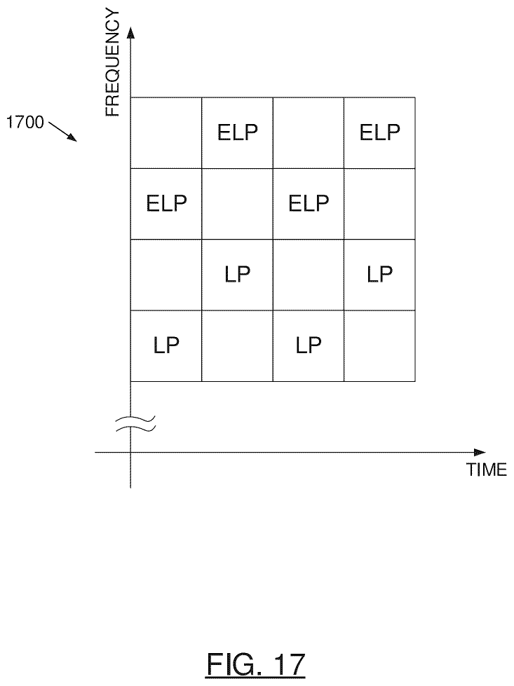

In one aspect of the present application, distinguishability of received chirp-based positioning signals may be enhanced by configuring the transmission of the chirp-based positioning signals to occur using distinct time and frequency resources, as illustrated in FIG. 17. FIG. 17 illustrates a grid 1700 of resources defined by frequency slots and time slots. In a resource defined, by a particular frequency slot in combination with a particular time slot, to be specific to serving low power UEs, the SMF 176 may configure a TX-AN node to use a specific starting frequency, ft. In a resource defined, by a different frequency slot in combination with a different time slot, to be specific to serving extremely low power UEs, the SMF 176 may configure a target UE to use a particular signature, fⱼ.

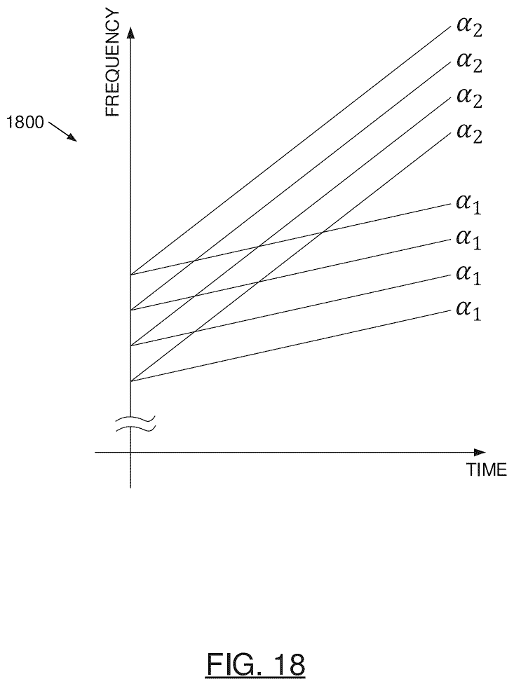

In another aspect of the present application, distinguishability of received chirp-based positioning signals may be enhanced by configuring the transmission of the chirp-based positioning signals to occur using distinct chirp rates, as illustrated in FIG. 18. In a plot 1800 in FIG. 18, four chirp-based positioning signals are illustrated as using a first chirp rate, α₁, and four chirp-based positioning signals are illustrated as using a first chirp rate, α₂.

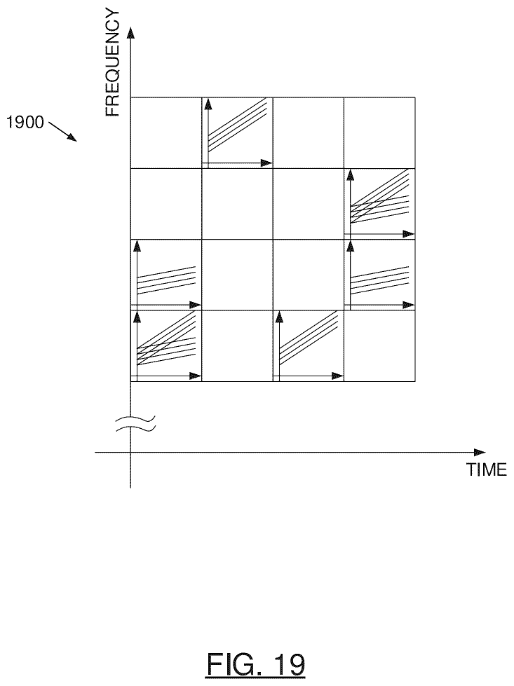

In a further aspect of the present application, distinguishability of received chirp-based positioning signals may be enhanced by configuring the transmission of the chirp-based positioning signals to occur using a hybrid approach, wherein a mix of distinct time and frequency resources are defined and distinct chirp rates are used within the defined resources, as illustrated in FIG. 19. FIG. 19 illustrates a grid 1900 of resources defined by frequency slots and time slots. A given time/frequency resource in FIG. 19 may have chirp-based positioning signals defined to use a single chirp rate or a plurality of chirp rates.

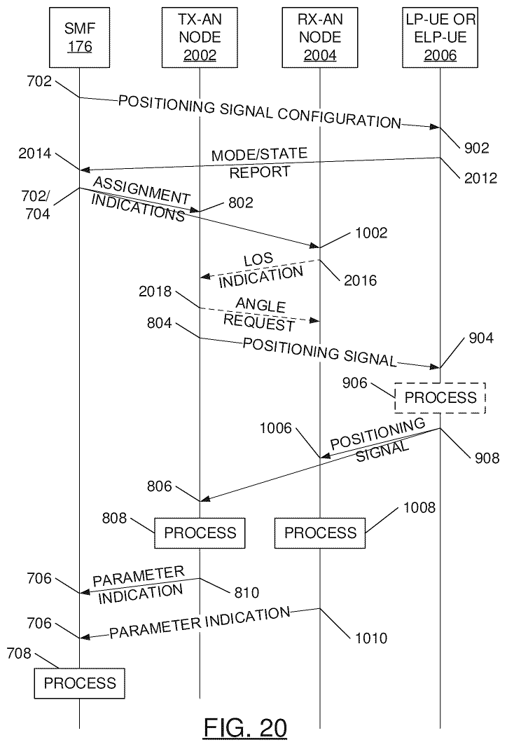

FIG. 20 illustrates, in a signal flow diagram, communication between the SMF 176, a TX-AN node 2002, an RX-AN node 2004 and a UE 2006. The UE 2006 may be understood to represent a low power UE or an extremely low power UE. Initially, the SMF 176 may provide (step 702, see FIG. 7) chirp-based positioning signal configurations to the UE 2006, with the expectation that the UE 2006 will enter into a low power mode. Alternatively, the SMF 176 may provide (step 702, see FIG. 7) backscattering configurations to the UE 2006, with the expectation that the UE 2006 will enter into an extremely low power mode. These configurations may be provided (step 702) using control signaling, e.g., RRC signaling or as part of a media access control-control element (a “MAC-CE”).

The UE 2006 may then transmit (step 2012) a mode/state report, including an indication that the UE 2006 is about to enter into either the low power mode or the extremely power mode. Upon receiving (step 2014) the mode/state report, the SMF 176 may assign (step 704) anchor nodes (the TX-AN node 2002, the RX-AN node 2004) for the target UE 2006. The assigning (step 704) may be, in part, based on coarse positioning information about the target UE 2006 while taking into consideration the type of the low power mode that was indicated in the mode/state report.

For example, responsive to the mode/state report indicating an extremely low power mode for the target UE 2006, the SMF 176 may assign anchor nodes that are in the proximity of the target UE 2006. This proximity enhances a likelihood of reliable reception, at the anchor nodes, of backscattered chirp-based positioning signals associated with ELP-specific positioning procedures, discussed hereinbefore. The SMF 176 may accompany transmission (step 704) of assignments with transmission (step 702), to both the TX-AN node 2002 and the RX-AN node 2004, of chirp-based positioning signal configurations.

After receiving (step 1002) an anchor assignment and a chirp-based positioning signal configuration, the RX-AN node 2004 may transmit (step 2016) a LOS indication to the TX-AN node 2002. TX-ANs may respond by transmitting (step 2018), to the RX-AN node 2004, a request for some angular measurements. The transmission (step 2016) of the LOS indication and the transmission (step 2018) of the request are optional and may be utilized when the SMF 176 fails to find multiple RX-AN nodes or when there is an incentive to increase reliability and accuracy of the various positioning procedures.

The TX-AN node 2002 transmits (step 804) a forward chirp-based positioning signal. The forward chirp-based positioning signal may be considered as a sort of an analog PRS.

As part of entering into low power mode, the target UE 2006 may turn on a matched filter. Upon receiving (step 904) the forward chirp-based positioning signal, the target UE 2006 may obtain some measurements and process (step 906) the forward chirp-based positioning signal. As discussed hereinbefore, the processing (step 906) may involve both RF-processing, e.g., matched filtering, and some limited digital processing. The target UE 2006 may then transmit (step 910) a reverse chirp-based positioning signal.

As part of entering into extremely low power mode, the target UE 2006 may turn on a backscattering receiver. Upon receiving (step 904) the forward chirp-based positioning signal, the target UE 2006 may backscatter, i.e., transmit, (step 910) a reverse chirp-based positioning signal with a signature applied. The transmission (step 910) of a reverse chirp-based positioning signal with a signature applied may be considered as an analog peer of transmitting a digital SRS.

The RX-AN node 2004 may receive (step 1006) the reverse chirp-based positioning signal and process (step 1008) measurements of the reverse chirp-based positioning signal to obtain parameters. The RX-AN node 2004 may then transmit (step 1010), to the 176 or another network entity, an indication of the parameters.

Similarly, the TX-AN node 2002 may receive (step 806) the reverse chirp-based positioning signal and process (step 808) measurements of the reverse chirp-based positioning signal to obtain parameters. The TX-AN node 2002 may then transmit (step 810), to the SMF 176 or another network entity, an indication of the parameters.

Upon receiving (step 706) the parameters, the SMF 176 may process (step 708) the parameters to obtain position information for the target UE 2006.

In the event the SMF 176 is co-located with any other network node (e.g., the TX-AN node 2002 or the RX-AN node 2004), appropriate modifications to the transmissions and receptions in the method of FIG. 20 may be implemented and apparent to persons skilled in the art.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method, comprising:
receiving, at a network anchor node, configuration information;
receiving, at the network anchor node, a second positioning signal, wherein the second positioning signal corresponds to a first positioning signal as altered by a target user equipment (UE), wherein the first positioning signal has been defined in the configuration information;
obtaining, at the network anchor node, a plurality of parameters from the second positioning signal; and
transmitting, from the network anchor node to a position-obtaining node, indications of the plurality of parameters.

2. The method of claim 1, wherein the plurality of parameters comprises one or more of: an estimate of a distance between the network anchor node and the target UE, or an angle of arrival for the second positioning signal.

3. The method of claim 1, further comprising:
transmitting, from the network anchor node, the first positioning signal in accordance with the configuration information.

4. The method of claim 1, further comprising:
receiving, at the network anchor node, an indication that the network anchor node has been assigned as an anchor node for the target UE.

5. A method, comprising:
receiving, at a target user equipment (UE), configuration information for a positioning signal;
receiving, at the target UE, a first positioning signal according to the configuration information;
altering, at the target UE, the first positioning signal to generate a second positioning signal; and
transmitting, at the target UE, the second positioning signal.

6. The method of claim 5, wherein the altering the first positioning signal comprises time-shifting the first positioning signal.

7. The method of claim 5, wherein the transmitting the second positioning signal comprises backscattering the first positioning signal.

8. The method of claim 7, wherein the altering the first positioning signal comprises applying a signature to the first positioning signal during the backscattering.

9. The method of claim 8, wherein the signature comprises a frequency specified in the configuration information.

10. The method of claim 8, wherein the applying is after a delay, the configuration information indicating the delay.

11. An apparatus comprising:
at least one processor; and
a memory storing instructions which, when executed by the at least one processor, cause the apparatus to perform:
receiving configuration information;
receiving a second positioning signal, wherein the second positioning signal corresponds to a first positioning signal as altered by a target user equipment (UE), wherein the first positioning signal has been defined in the configuration information;
obtaining a plurality of parameters from the second positioning signal; and
transmitting, to a position-obtaining node, indications of the plurality of parameters.

12. The apparatus of claim 11, wherein the plurality of parameters comprises one or more of: an estimate of a distance between the apparatus and the target UE, or an angle of arrival for the second positioning signal.

13. The apparatus of claim 11, the instructions, when executed by the at least one processor, further causing the apparatus to perform:
transmitting the first positioning signal in accordance with the configuration information.

14. The apparatus of claim 11, the instructions, when executed by the at least one processor, further causing the apparatus to perform:
receiving an indication that the apparatus has been assigned as an anchor node for the target UE.

15. An apparatus comprising:
at least one processor; and
a memory storing instructions which, when executed by the at least one processor, cause the apparatus to perform:
receiving configuration information for a positioning signal;
receiving a first positioning signal according to the configuration information;
altering the first positioning signal to generate a second positioning signal; and
transmitting the second positioning signal.

16. The apparatus of claim 15, wherein the altering the first positioning signal comprises time-shifting the first positioning signal.

17. The apparatus of claim 15, wherein the transmitting the second positioning signal comprises backscattering the first positioning signal.

18. The apparatus of claim 17, wherein the altering the first positioning signal comprises applying a signature to the first positioning signal during the backscattering.

19. The apparatus of claim 18, wherein the signature comprises a frequency specified in the configuration information.

20. The apparatus of claim 18, wherein the applying is after a delay, the configuration information indicating the delay.
